(19) United States
(12) Patent Application Publication
(10) Pub. No.: US 2016/0034974 A1
(43) Pub. Date: Feb. 4, 2016

(54) METHOD, A SYSTEM AND A MOBILE APP FOR PROVIDING AN INFLUENCER WITH AN OFFER TO ENDORSE A BRAND'S PRODUCT OR SERVICE

(71) Applicant: Ravi Neb, Noida (IN)

(72) Inventor: Ravi Neb, Noida (IN)

(21) Appl. No.: 14/538,472

(22) Filed: Nov. 11, 2014

(30) Foreign Application Priority Data
Jul. 31, 2014 (IN) 2174/DEL/2014

(51) Int. Cl. G06Q 30/02; G06Q 50/00

(52) U.S. Cl. CPC G06Q 30/0276; G06Q 30/0214; G06Q 50/01

(57) ABSTRACT

An advertising system for providing an influencer with an offer to endorse a brand's product or service is also disclosed. The advertising system is selectively in operative communication with one or more influencers and one or more brands. The advertising system comprises of an influencer data repository configured to store the data relating to a plurality of registered influencers and a brand data repository configured to store the data relating to a plurality of brand's offering product or service for endorsement. The advertising system further comprises of an advertising engine, selectively in operative communication with influencer data repository, configured to select an influencer to endorse at least one product or service offered by a brand and formulate an offer for the selected influencer to endorse at least one product or service. The advertising engine is further configured to notify the selected influencer of the offer and provide the selected influencer to endorse the product or service upon a successful approval from the influencer.

### FIELD OF THE INVENTION

The invention relates to online web based advertising system and a mobile app. More particularly, the invention relates to a system and method for selecting suitable influencers or endorsers available on the system for endorsement of any particular product or service.

### BACKGROUND OF THE INVENTION

The following background discussion includes information that may be useful in understanding the present invention. It is not an admission that any of the information provided herein is prior art or relevant to the presently claimed invention, or that any publication specifically or implicitly referenced is prior art.

Nowadays, endorsements or advertisements are very necessary for success of any brand's product or services. Endorsements through influencers such as celebrities are a popular means to increase awareness and reach of the product or services among the target customers. Selecting a right influencer for a brand can be a difficult task for brand owners as generally, impact of influencer's popularity and other characteristics on the brand is unknown and hard to predict. Influencer's age, location, sex, area of work, social media presence and other critical parameters have great impacts on a successful endorsement for any particular brand's product or service. Thus, selecting a right influencer or endorser is very critical in respect to the success of endorsement.

Also, in the present age of internet and mobility it is a requirement now that brand owners can select and communicate with endorser through a smart mobile device or other means of communication which are handy and can be used while on the go. One of the ways may be through a dedicated ‘mobile app’. The mobile app marketplace is growing by leaps and bounds. However, there is very limited participation in the space for dedicated mobile apps for influencers. Such dedicated apps could enhance influencer profiles, create brand-influencer interactions and create new avenues of revenue. The only mobile app activity presently related to this field is apps focused on a company, league, or team.

Various web based influencer endorsement or advertisement systems have recently been developed and provides a system for recommending an influencer to brand owner but recommending an influencer is merely based on age, location and other information, provided by influencer itself. This kind of recommendation cannot be said intelligent as it does not tell about the impact of influencer's popularity and other important parameters on brand's product or services.

In another approach, a system is defined where a brand owner can approach an endorser for advertisement through a mobile application software program but again system fails to provide recommendation of right endorser among of plurality of endorsers because of the single endorser centric nature of the mobile application software program.

In other approaches, various methods are described where brand owners can put some criteria and obtain filtered result of influencer suggestions for endorsement but the method again lacks intelligent match or suggestions for brand owner's requirement as suggestions are completely based upon criteria set by brand owners. There may be possibilities that criteria set by brand owners are not very accurate or broad. So, it is not advisable to solely depend on criteria provided by brand owners.

Hence, there is a need for overcoming at least the above-mentioned shortcomings in the prior art and providing an improved advertisement/endorsement system, methods and a mobile app thereof.

### SUMMARY OF THE INVENTION

A method for providing an influencer with an offer to endorse a brand's product or service over an advertising system is disclosed. The advertising system is selectively in operative communication with one or more influencers and one or more brands. The method comprises the steps of selecting an influencer to endorse at least one product or service offered by a brand and formulating an offer for the selected influencer to endorse at least one product or service by the brand. The offer comprises of an influencer identifier, a product identifier, a payment model and time period for endorsement. The method further comprises of notifying the selected influencer of the offer and providing the selected influencer to endorse the product or service upon a successful approval from the influencer.

An advertising system for providing an influencer with an offer to endorse a brand's product or service is also disclosed. The advertising system is selectively in operative communication with one or more influencers and one or more brands. The advertising system comprises of an influencer data repository configured to store the data relating to a plurality of registered influencers and a brand data repository configured to store the data relating to a plurality of brand's offering product or service for endorsement. The advertising system further comprises of an advertising engine, selectively in operative communication with influencer data repository, configured to select an influencer to endorse at least one product or service offered by a brand and formulate an offer for the selected influencer to endorse at least one product or service. The advertising engine is further configured to notify the selected influencer of the offer and provide the selected influencer to endorse the product or service upon a successful approval from the influencer.

A mobile software application for an influencer device is also disclosed. The mobile software application is selectively in operative communication with an advertising system. The mobile software application comprises of a data repository for storing data and a processor, selectively in operative communication with the data repository, configured to receive an offer for endorsement of products or service from a brand and provides the influencer an option to accept or reject or negotiate the offer. The mobile software application further comprises of a user interface, selectively in operative communication with the processor, configured to provide an influencer at least one capability from the group comprising: viewing profile of the influencer; viewing statistics pertaining to the influencer; accepting and/or rejecting offers provided by a brand; managing offers and earnings.

A system is also disclosed. The system comprises of an advertising system, having an advertising engine, for providing an influencer with an offer to endorse a brand's product or service and a mobile software application installed on an influencer device for receiving an offer for endorsement of products or service from a brand.

A computer program for providing an influencer with an offer to endorse a brand's product or service is also disclosed. The computer program comprises of a code means which when run on advertising system, causes the advertising system to select an influencer to endorse at least one product or service offered by a brand; formulate an offer for the selected influencer to endorse at least one product or service by the brand; the offer comprises of an influencer identifier, a product identifier, a payment model and time period for endorsement; notify the selected influencer of the offer and provide the selected influencer to endorse the product or service upon a successful approval from the influencer.

A computer program product is also disclosed. The computer program product comprises of a computer readable code means and a computer program as disclosed above.

### BRIEF DESCRIPTION OF THE DRAWINGS

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 illustrates a functional diagram of a network system in accordance with an embodiment of the invention;

FIG. 2 illustrates a schematic diagram of a mobile software application in accordance with an embodiment of the present invention;

FIG. 3 illustrates a schematic diagram of an advertising system in accordance with a first embodiment of the present invention;

FIG. 4 illustrates a flowchart showing a method for providing an influencer with an offer to endorse a brand's product or service over an advertising system in accordance with the first embodiment of the present invention;

FIG. 5 illustrates a schematic diagram of an advertising system in accordance with a second embodiment of the present invention;

FIG. 6 illustrates a flowchart showing a method for automatically selecting an influencer suitable for endorsement of a product or service over advertising system in accordance with the second embodiment of the present invention;

FIG. 7 illustrates a screenshot of the home page of the mobile app in accordance with an embodiment of the present invention;

FIG. 8 illustrates a screenshot of the welcome pages of the mobile app in accordance with an embodiment of the present invention;

FIG. 9 illustrates a screenshot of the registration process in accordance with an embodiment of the present invention;

FIG. 10 illustrates a screenshot of the menu page of the mobile app in accordance with an embodiment of the present invention;

FIG. 11 illustrates a screenshot of a page of the mobile app showing new offers to influencer in accordance with an embodiment of the present invention;

FIG. 12 illustrates a screenshot of a page of the mobile app showing offer details for the new offer in accordance with an embodiment of the present invention;

FIG. 13 illustrates a screenshot of a page of the mobile app showing accepted offers by influencer in accordance with an embodiment of the present invention;

FIG. 14 illustrates a screenshot of a page of the mobile app showing the influencer executing the offer on social media in accordance with an embodiment of the present invention;

FIG. 15 illustrates a screenshot of a page of the mobile app showing the offers of today that the influencer has to execute in accordance with an embodiment of the present invention;

FIG. 16 illustrates a screenshot of a page of the mobile app showing the earning of the influencer from the current deals in accordance with an embodiment of the present invention;

FIG. 17 illustrates a screenshot of a page of the mobile app showing the influencer analytics in accordance with an embodiment of the present invention;

FIG. 18 illustrates a screenshot of a page of the mobile app showing the influencer profile in accordance with an embodiment of the present invention;

FIG. 19 illustrates a screenshot of a page of the mobile app showing the editing of an influencer profile in accordance with an embodiment of the present invention;

FIG. 20 illustrates a screenshot of page of the mobile app showing adding bank details of the influencer in accordance with an embodiment of the present invention;

FIG. 21 illustrates a of a page of the mobile app showing the influencer notifications in accordance with an embodiment of the present invention;

FIG. 22 illustrates a screenshot of a page of the brand interface showing the dashboard for brands in accordance with an embodiment of the present invention;

FIG. 23 illustrates a screenshot of a page of the brand interface showing the influencer marketplace having details of all the influencers in accordance with an embodiment of the present invention;

FIG. 24 illustrates a screenshot of a page of the brand interface showing the active influencers for a brand in accordance with an embodiment of the present invention;

FIG. 25 illustrates a screenshot of a page of the brand interface showing an influencer profile in accordance with an embodiment of the present invention;

FIG. 26 illustrates a screenshot of a page of the brand interface showing making an offer by selecting the social medium and offer payment type in accordance with an embodiment of the present invention;

FIG. 27 illustrates a screenshot of a page of the brand interface showing step 1 of creating an offer to an influencer in accordance with an embodiment of the present invention;

FIG. 28 illustrates a screenshot of a page of the brand interface showing step 1 of creating an offer to an influencer in accordance with an embodiment of the present invention;

FIG. 29 illustrates a screenshot of a page of the brand interface showing step 2 of creating an offer to an influencer in accordance with an embodiment of the present invention;

FIG. 30 illustrates a screenshot of a page of the brand interface showing step 2 of creating an offer to an influencer in accordance with an embodiment of the present invention;

FIG. 31 illustrates a screenshot of a page of the brand interface showing step 3 of creating an offer to an influencer in accordance with an embodiment of the present invention;

FIG. 32 illustrates a screenshot of a page of the brand interface showing the analytics of the brand in accordance with an embodiment of the present invention;

FIG. 33 illustrates a screenshot of a page of the brand interface showing the analytics of the brand in accordance with an embodiment of the present invention;

FIG. 34 illustrates a screenshot of a page of the brand interface showing the billings of the brand in accordance with an embodiment of the present invention;

FIG. 35 illustrates a screenshot of a page of the brand interface showing the new/pending offers to the influencers created by the brand in accordance with an embodiment of the present invention;

FIG. 36 illustrates a screenshot of a page of the brand interface showing the accepted offers by influencers created by the brand in accordance with an embodiment of the present invention;

FIG. 37 illustrates a screenshot of a page of the brand interface showing the completed offers by influencers in accordance with an embodiment of the present invention;

FIG. 38 illustrates a screenshot of a page of the brand interface showing the incomplete offers by influencers in accordance with an embodiment of the present invention;

FIG. 39 illustrates a screenshot of a page of the brand interface showing the rejected offers by influencers in accordance with an embodiment of the present invention;

FIG. 40 illustrates a screenshot of a page of the brand interface showing the setting page for filling in bank details of brand in accordance with an embodiment of the present invention;

FIG. 41 illustrates a screenshot of a page of the brand interface showing the setting page for completing the brand profile details in accordance with an embodiment of the present invention; and

FIG. 42 illustrates a typical hardware configuration of a computer system, which is representative of a hardware environment for practicing the present invention.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures proceeded by “comprises . . . a” does not, without more constraints, preclude the existence of other devices or other sub-systems or other elements or other structures or additional devices or additional sub-systems or additional elements or additional structures.

Unless otherwise defined, all technical and scientific terms used herein have the same meaning as commonly understood by one of ordinary skill in the art to which this invention belongs. The system, method, mobile app and examples provided herein are illustrative only and not intended to be limiting.

Embodiments of the present invention will be described below in detail with reference to the accompanying drawings.

A web based advertising system, a method and a ‘mobile app’, is disclosed herein, where the brand owners and influencers may remain in communication and may provide improved ways of recommending an influencer to brand owners in which an intelligent matching must be performed for any product or service provided by brand owner such that most suitable and eligible influencer may be selected for endorsement.

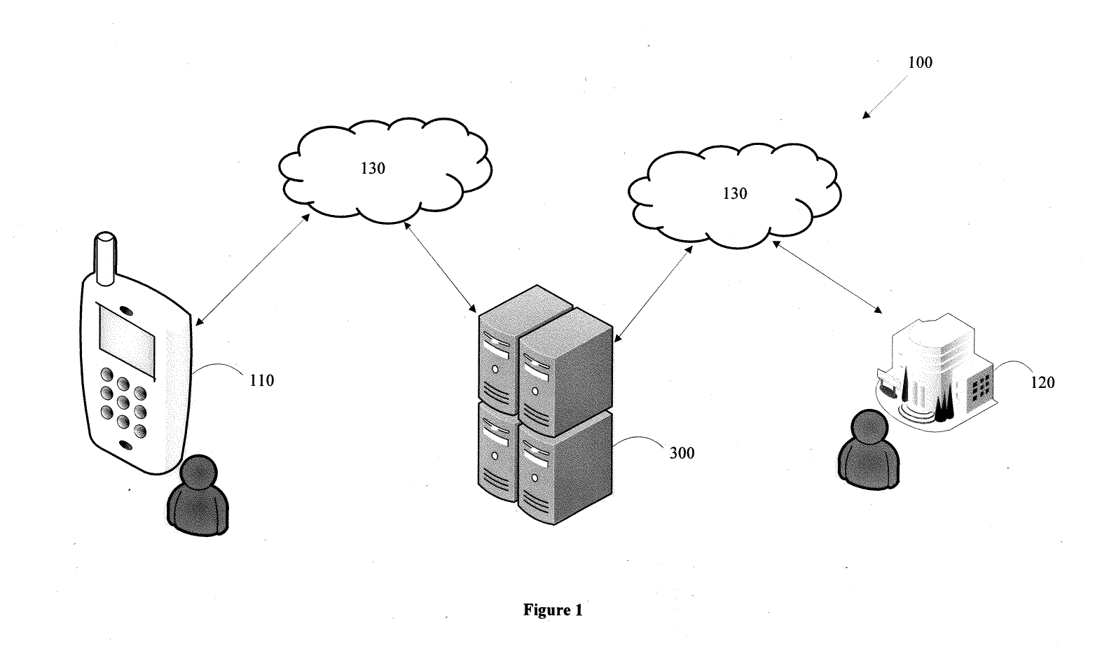

FIG. 1 illustrates a functional diagram of a network system in accordance with an embodiment of the invention. The network system 100 comprises of an advertising system 300 connected to an influencer device 110 over a network 130 and connected to a brand owner or brand server 120 over a network 130. The advertising system 300 is configured to provide an influencer with an offer to endorse a brand's product or service over a network 130. Further, the advertising system 300 provides a mobile software application or commonly known as ‘mobile app’ customized for the influencers as an influencer application to be installed on an influencer device. Also, the advertising system 300 is configured to provide a brand interface customized for the brand owners to propose and manage offer to influencers.

The mobile software application on the influencer device 110 is configured to accept, refuse or negotiate the offer and transmit the information to the advertising system 300. The brand owners provide an offer for endorsing a particular influencer to the advertising system and the advertising system forwards and manages the offer between the brand owners and the influencer.

The influencer device 110 may be any device capable of data communication over a wireless communication network such as mobile device, smart phone, a personal digital assistant (PDA) or any other similar device.

In an alternate embodiment, the influencer device 110 may be a personal computer, a laptop, a palm top or any other computing device. The network 130 may be any wired or wireless communication network such as but not limited to a Local Area Network (LAN), a Wide Area Network (WAN), or so forth.

The brand owners 120 may be a representative of a brand or a brand server providing an endorsement of their products or services to an influencer.

In a preferred embodiment, the influencer device 110 is a smart mobile communication device. In another embodiment, the network 130 is a cellular network or a data network for connecting the advertising system 300 to influencer device 110 and brand owner 120.

In accordance with an aspect of the invention, the software components of the network system are the mobile software application, brand platform/interface and admin platform.

The mobile software application or the mobile app is available via different web app stores that may be downloaded and installed on any android, iOS, windows based smart mobile devices. This enables influencers to register on the app and manage their profiles and offers. The mobile app may provide the influencer with one or more of the following functionalities: register, view, accept, reject offers, notifications and alerts, manage profile, reports and analytics, interact with social media via tweets or posts and helps and FAQ's.

The brand platform/interface enable the brand owners or administrators to view influencer market place, view their social stats and make multiple offers. The brand platform/interface may provide the influencer with one or more of the following functionalities: view market place, view social stats, create, modify, delete offers, send offers to influencers, reports and analytics, messages, alerts and manage brand profile.

The admin platform enables the platform administrator to view, activate, deactivate, etc. influencers and brands registered within the advertising system. The admin platform can also view different analytics and reports to analyze business.

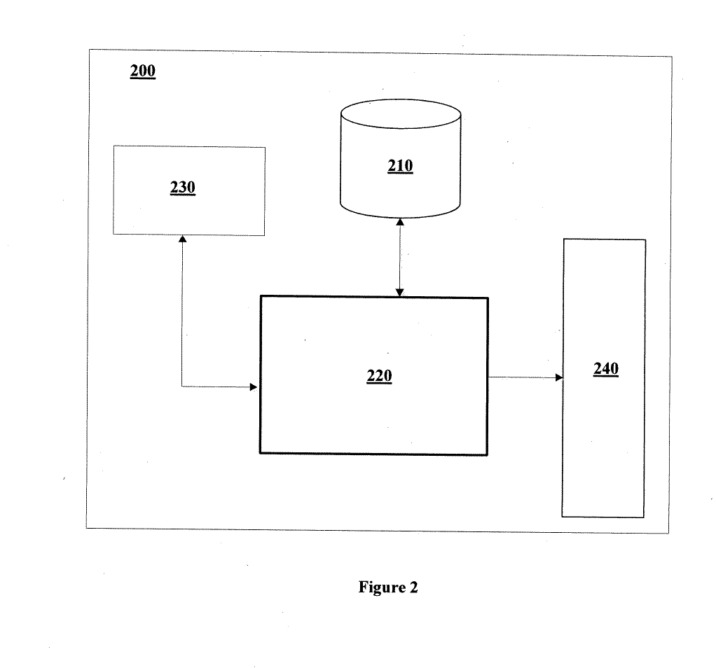

FIG. 2 illustrates a schematic diagram of a mobile software application in accordance with an embodiment of the present invention. The mobile software application 200 may comprise of a data repository 210, a processor 220, a user interface 230 and a mobile interface 240. According to a preferred embodiment, the mobile software application is a mobile client or commonly termed as ‘mobile app’.

The data repository 210, the user interface 230 and the mobile interface 240 are controlled by the processor 220. The mobile software application may be directly connected to the advertising system 300.

The mobile software application may be present on the mobile communication device of the influencer or reside in a SIM card. The mobile software application is directly linked to the advertising system or any other upgrade server for upgrades, alerts and processing of the data. In accordance with an embodiment, the influencer device is equipped with a mobile software application and adapted to receive and display data contents such as applets, menus, etc. The mobile software application may be an application software or dynamic menus built specifically for mobile communication devices. The mobile software application may be downloaded from the World Wide Web or may be provided as functionality on the SIM card or can be pushed by the advertising system onto the mobile device of the influencer.

In accordance with an aspect, the mobile software application is a small mobile application and may be easily stored on the SIM card or the storage area of the mobile device and may be provided with interfaces for the operating system of the mobile device.

The mobile software application enables seamless communication between the mobile device and the advertising system regardless of underlying communications protocols. The advertising system or a push server can identify mobile device capabilities and can cause data contents to be adapted to accommodate display and input limitations of mobile device.

The data repository 210 is selectively in operative communication with the processor 220 and configured to store the data send by the advertising system. The data repository 210 may contains a table and stores the data in a table format.

The user interface 230 is selectively in operative communication with the processor and configured to provide an influencer to view their profiles; view statistics; accepting/rejecting/negotiating offers provided by a brand; managing offers; earnings, etc. In accordance with a preferred embodiment, the user interface is a touch screen display. The user interface 230 provides an influencer with a menu type interface.

The mobile interface 240 is selectively in operative communication with the processor and configured to transmit the data executed by the processor to the advertising system.

The processor 220 is selectively in operative communication with the data repository 210 and configured to receive an offer for endorsement of products or service from a brand owner and provides the influencer an option to accept or reject or negotiate the offer.

In accordance with an embodiment, the processor 220 is further configured to accept the offer for endorsing the product or service upon a accept input received from the influencer.

In accordance with an embodiment, the processor 220 is further configured to negotiate the offer for endorsing the product or service upon a query input received from the influencer with regards to the payment model or time period.

In accordance with another embodiment, the processor 220 is further configured to reject the offer for endorsing the product or service upon a decline input received from the influencer based on an inept payment model or stringent time period.

In accordance with a preferred embodiment, the mobile software application, upon successful installation on an influencer device, interacts with a web existence of the influencer. The web existence resides on a social networking website such as Facebook, Twitter, LinkedIn, Instagram, Pininterest, etc.

In accordance with another preferred embodiment, the mobile software application allows the influencer to logon to a registered social network account such that influencer interacts with the web through the social network account.

In accordance with another preferred embodiment, the mobile software application allows the influencer to automatically place their posts with regard to endorsement or advertisements on their social network account.

In accordance with another preferred embodiment, the mobile software application provides an option to an influencer to choose a brand or approach the brand for endorsement of a particular product or services of the brand.

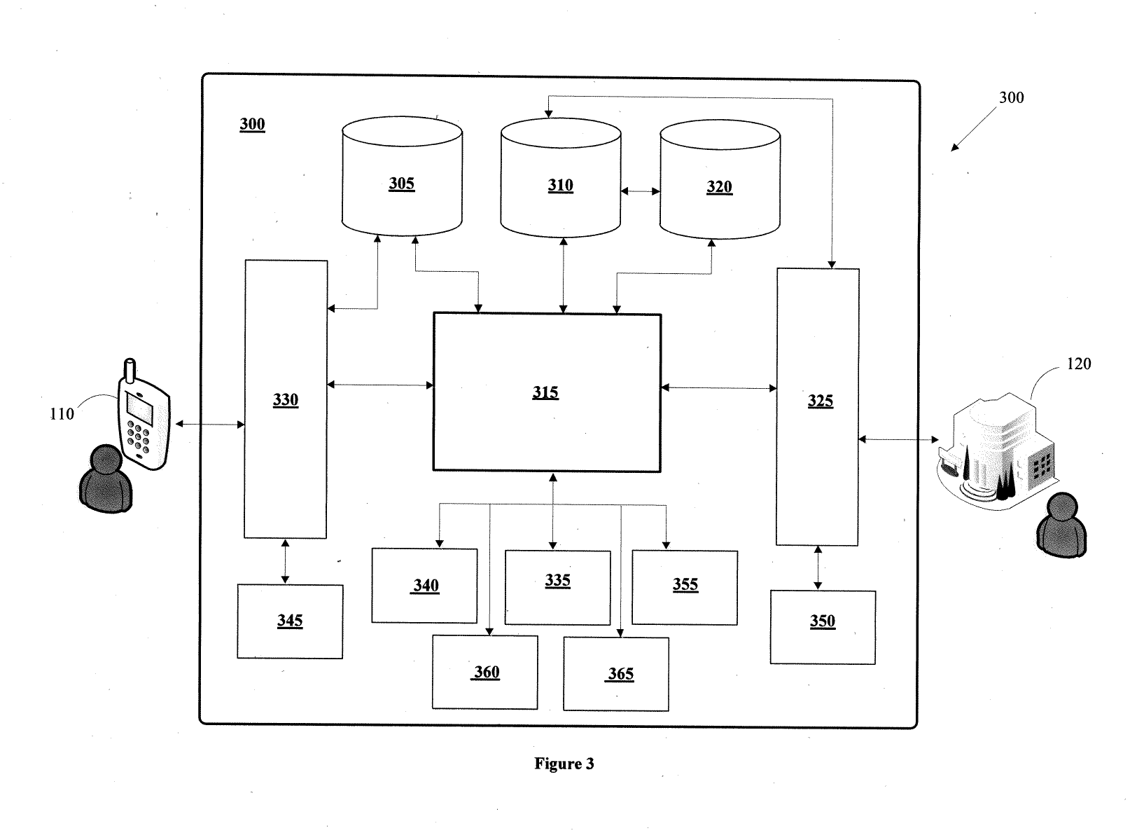

FIG. 3 illustrates a schematic diagram of an advertising system in accordance with a first embodiment of the present invention. The advertising system 300 is configured to provide an influencer with an offer to endorse a brand's product or service.

The advertising system 300 may comprise of an influencer database 305, a brand data repository 310, an advertising engine 315, an offer data repository 320, a brand interface 325, an influencer interface 330, a channel integration platform 335, a registration module 340, an influencer content module 345, a brand content module 350, a reconciliation module 355, a charging module 360 and a admin platform 365.

According to a preferred embodiment, the advertising system is a server acting as an intermediate between the influencers and the brand owners (may be referred to as brands in the specification).

The influencer data repository 305 is selectively in operative communication with the advertising engine 315 and the influencer interface 330. The influencer data repository 305 is configured to store the data relating to a plurality of registered influencers. The influencer data repository 305 may contains the details such as name, address, bank details, sex, endorsements, price, etc. of the influencers. The data may be stored in the table format with the influencer ID being the primary key of the table.

The brand data repository 310 is selectively in operative communication with the advertising engine 315 and the brand interface 325. The brand data repository 310 is configured to store the data relating to a plurality of product or service offered by brands for endorsement. The brand data repository 310 may contain details such as name & address of brand, bank details, products & services offered for endorsements, payment models, etc. The data may be stored in the table format with the brand ID or product ID being the primary key of the table.

The advertising engine 315, in operative communication with influencer data repository 305 and brand data repository 310, configured to select an influencer to endorse at least one product or service offered by a brand 120 and formulate an offer for the selected influencer to endorse at least one product or service. The advertising engine 315 is further configured to notify the selected influencer of the offer and provide the selected influencer to endorse the product or service upon a successful approval from the influencer.

In an embodiment of the invention, the advertising engine 315 selects the influencer by evaluating the influencer's awareness, appeal and relevance to a brand's image and their influence on consumer buying behavior. In another embodiment of the invention, selection of the influencer may be based on previous endorsements of the influencer with regards to the category of products or services offered by the brand. In another embodiment of the invention, the advertising engine 315 notifies the identified influencer on a mobile software application or ‘mobile app’ of the influencer device.

The offer data repository 320 is selectively in operative communication with the advertising engine 315 and the brand interface 325. The offer data repository 320 is configured to store the data relating to offers such as an influencer identifier, a product identifier, an offer identifier, a payment model and time period for endorsement. The data may be stored in the table format with the offer identifier being the primary key of the table. The offer data repository 320 may be a relational database in operative communication with the influencer data repository 305 and brand data repository 310.

The brand interface 325 is selectively in operative communication with the advertising engine 315 and brand owner 120 and configured to receive data from an administrator representing as a brand or a server associated with the brand. The brand interface 325 further communicates with the brand owner 120 with regard to approval/refusal/negotiation of offers, payments, billing, notifications, etc.

The influencer interface 330, selectively in operative communication with the advertising engine and the influencer and configured to transmit data to the mobile software application on the influencer device 110.

The channel integration platform 335 is selectively in operative communication with the advertising engine 315 and configured to perform security related and data integrity related checks on the content of the data. The Channel Integration Platform 335 may include a security protocol that performs security related and data integrity related checks on the data files. The security protocol may be SSL (Secure Socket Layer), TLS (Transport Layer Security), PPP (Point-to-Point protocol) or any other protocol known in the art.

The registration module 340 is selectively in operative communication with the influencer interface 330 and brand interface 325 and configured for registering one or more influencers and one or more brands.

The influencer content module 345 is selectively in operative communication with the influencer interface 330 and configured to provide a mobile software application and contents customized for the influencers to download as an influencer application on the influencer device.

The brand content module 350 is selectively in operative communication with the brand interface 325 and configured to provide the brand interface 325 with customized contents for proposing and managing offer to influencers.

The reconciliation module 355 is selectively in operative communication with the advertising engine 315 and operable to effect a payment transaction between the influencer 110 and a brand 120. The reconciliation module 355 imposes a settlement commission to the brand for providing an offer to the influencer using the advertising system 300.

The tracking module 360 is selectively in operative communication with the advertising engine 315 and configured to track the influencer posts or tweets on the internet or social networking website and further configured to track the likes, clicks, leads or transactions of the target audience that follow the influencer tweet or posts such that the payment estimation is accurate between the brand owner and influencer.

The admin platform 365 is selectively in operative communication with the advertising engine 315 and enables the platform administrator to view, activate, deactivate, etc. influencers and brands registered within the advertising system 300. The admin platform 365 may also view different analytics and reports to analyze business.

In accordance with an embodiment of the invention, the influencer is an influential person having the ability to endorse or market a brand's product or services. The influencer may be a sports person, an entertainer or a well-known individual.

In accordance with another embodiment of the invention, the payment models are Pay Per Tweet, Pay Per Click, Pay Per Lead and Pay Per Transaction. The above mentioned models are considered payment models for the influencer and brands. However, may be considered advertising models for the prospective customers or target audience. The advertising engine keeps a track of influencer post or tweet on the internet or social networking website and also keeps a track of the likes, clicks, leads or transactions of the target audience that follow the influencer tweet or posts such that the payment estimation is accurate between the brand owner and influencer.

Pay per tweet payment model provides the influencer with a pre-determined amount for every tweet posted on social networking websites with regards to the endorsed products or services. It is the easiest and fastest way to go viral about the brand's products or services.

Pay per click payment model provides the influencer with a pre-determined amount (decided between influencer and brand owner) for every click on a link provided by the influencer on the web. The pay per click pays for every click on a brand website only if a person/prospective customer clicks on a search engine result, link or banner and lands on the brands site. If the customer only sees the influencer link, but does not click through, this is called an impression and would not be able to quantify that under pay per click payment model. A well-managed pay per click advertising will bring traffic that achieves your goal, or ‘desired outcome’, when it comes to selling or advertising a brand's products and services.

Pay per lead payment model provides an influencer with a pre-determined amount for the posts put up by influencer leading to the brand website or leading to a sale of products or services. For example, the advertising system works when an influencer posts a banner for a customer to buy the products or services from the promotional banner. When that happens, a sale is generated. And in that case, influencer will have their commission and companies will have their sale.

Pay per transaction payment method provides an influencer with a pre-determined amount for the posts or banner or web links put by influencer leading to a sale of products or services that the influencer has endorsed from the brand or brand owners.

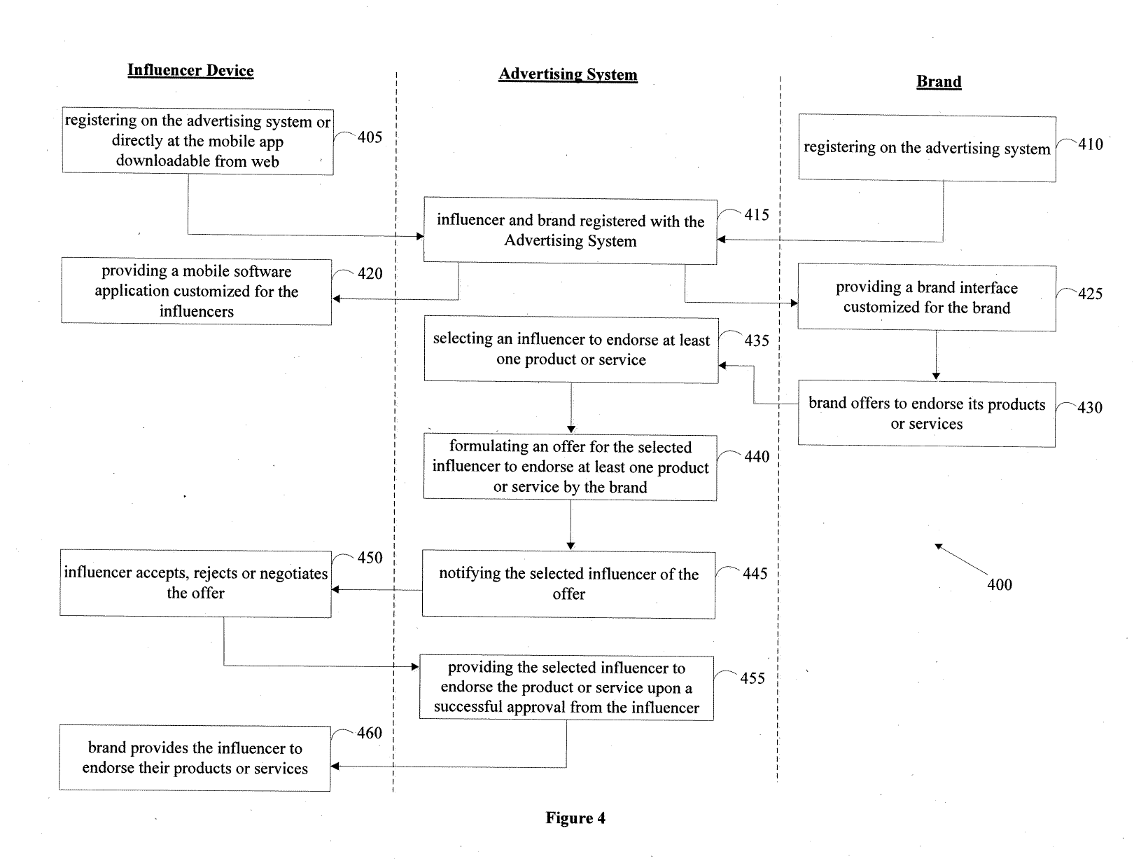

FIG. 4 illustrates a flowchart showing a method for providing an influencer with an offer to endorse a brand's product or service over an advertising system in accordance with the first embodiment of the present invention. The method comprises the steps of registering one or more influencers and one or more brands on the advertising system, as shown by step 405 and 410. The influencers may download the ‘mobile app’ available of the web and register thereon or may directly register with the advertising system. The brands may register directly on the advertising system 300.

The method further comprises the advertising system registering the influencers and brands as shown by step 415. Further, the method provides a mobile software application customized for the influencers as an influencer application to be installed on an influencer device, as shown by step 420. This is only the case if the influencer does not possess the influencer application on their device.

Further, the method provides a brand interface customized for the brand to propose and manage offer to influencers, as shown by step 425. The brand interface 425 may be a web platform available on the web which integrates the brand with the advertising system 300.

Further, the brand prepares an offer to endorse the products or services as shown by step 430. The brand transfer control over to the advertising system to select, offer and negotiate with the influencers on his behalf.

Further, the advertising system selects an influencer to endorse at least one product or service offered by a brand, as shown by step 435. The advertising system selects the influencer by evaluating an influencer's awareness, appeal and relevance to the brand's image and their influence on consumer buying behavior.

Further, the advertising system formulates an offer for the selected influencer to endorse at least one product or service by the brand, as shown by step 440. The offer is prepared on the line of the instructions received from the brand owners. The offer comprises of an influencer identifier, a product identifier, a payment model and time period for endorsement.

Further, the advertising system notifies the selected influencer of the offer, as shown by step 445. The advertising system notifies the identified influencer on the mobile software application of the influencer device.

Further, the influencer may accept/refuse/negotiate the offer presented by the brand, as shown by step 450. The influencer may negotiate or refuse the offer for endorsing the brand's product or service with regards to the payment model or time period.

Further, the advertising system provides the selected influencer to endorse the product or service upon a successful approval from the influencer, as shown by step 455 and 460.

In accordance with an embodiment of the invention, the payment model is Pay Per Tweet, Pay Per Lead and Pay Per Transaction.

In accordance with an embodiment of the invention, the advertising system charges the brand for providing an offer to the influencer on the advertising system.

A system is also disclosed. The system comprises of an advertising system, having an advertising engine, for providing an influencer with an offer to endorse a brand's product or service and a mobile software application installed on an influencer device for receiving an offer for endorsement of products or service from a brand.

A computer program for providing an influencer with an offer to endorse a brand's product or service is also disclosed. The computer program comprises of a code means which when run on advertising system, causes the advertising system to select an influencer to endorse at least one product or service offered by a brand; formulate an offer for the selected influencer to endorse at least one product or service by the brand; the offer comprises of an influencer identifier, a product identifier, a payment model and time period for endorsement; notify the selected influencer of the offer and provide the selected influencer to endorse the product or service upon a successful approval from the influencer.

A computer program product is also disclosed. The computer program product comprises of a computer readable code means and a computer program as disclosed above.

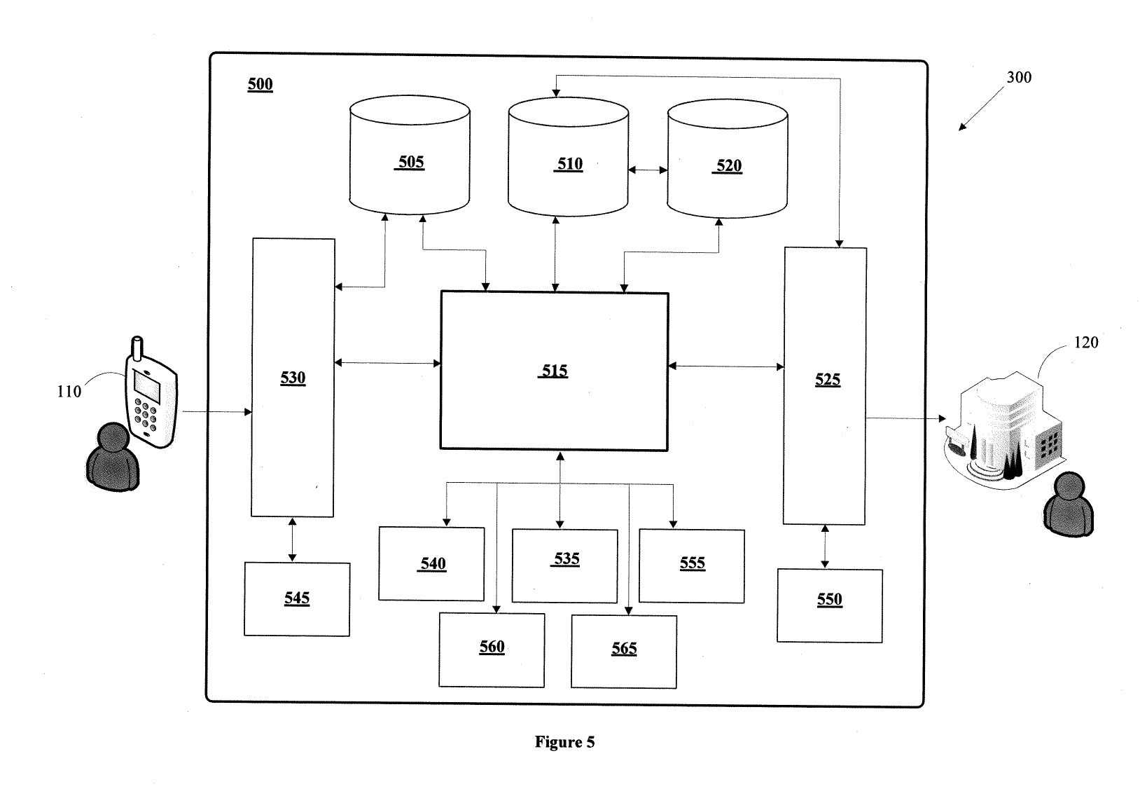

FIG. 5 illustrates a schematic diagram of an advertising system in accordance with a second embodiment of the present invention. The advertising system 500 is configured to provide an influencer with an offer to endorse a brand's product or service.

The advertising system 500 may comprise of an influencer database 505, a brand data repository 510, an advertising engine 515, an offer data repository 520, a brand interface 525, an influencer interface 530, a channel integration platform 535, a registration module 540, an influencer content module 545, a brand content module 550, a reconciliation module 555, a charging module 560 and a admin platform 565.

According to a preferred embodiment, the advertising system 500 is a server acting as an intermediate between the influencers and the brand owners (may be referred to as brands in the specification).

The influencer data repository 505 is selectively in operative communication with the advertising engine 515 and the influencer interface 530. The influencer data repository 505 is configured to store the data relating to a plurality of registered influencers. The influencer data repository 505 may contains the details such as name, address, bank details, sex, endorsements, price, etc., of the influencers. The data may be stored in the table format with the influencer ID being the primary key of the table.

The brand data repository 510 is selectively in operative communication with the advertising engine 515 and the brand interface 525. The brand data repository 510 is configured to store the data relating to a plurality of product or service offered by brands for endorsement. The brand data repository 510 may contain details such as name & address of brand, bank details, products & services offered for endorsements, payment models, etc. The data may be stored in the table format with the brand ID or product ID being the primary key of the table.

The advertising engine 515 is selectively in operative communication with influencer data repository 505 and brand data repository 510. The advertising engine 515 is configured to select an influencer to endorse at least one product or service by an influencer-brand metric. In accordance with an embodiment of the invention, the influencer-brand metric comprises of a plurality of identifiers to automatically evaluate an influencer's awareness, appeal and relevance to a brand's image and their influence on consumer buying behavior. In accordance with another embodiment of the invention, each identifier may maintain a score to evaluate the influencers appeal and relevance.

In accordance with another embodiment of the invention, the influencer-brand metric comprises of a plurality of static identifiers and a plurality of dynamic identifiers, with both defining a score for an influencer suitable for endorsing a brand's product or service.

In accordance with another embodiment of the invention, the static identifiers include one or more of the following identifiers: endorsements completed, active presence on social websites, number of followers/fan/friends, hiring expenditure cost and success rate.

In accordance with another embodiment of the invention, the dynamic identifiers include one or more of the following identifiers: location, age, product category match, previous association between brand and influencer and competitive analysis.

In accordance with an aspect of the invention, the influencer-brand metric comprises of a plurality of static identifier and a plurality of dynamic identifiers with each defining a score for an influencer which is generated by the advertising system 500 and assigned to influencer in reference.

On the basis of scores assigned to influencer, brand owners selects influencer for advertisement or endorsement of their brand. The influencer-brand metric generation is an automated process performed by the advertising system. For any influencer in question, the advertising system 500 generates two types of scores, Static Score X for static identifiers and Dynamic Score Y for dynamic identifiers. Now final Score for any Influencer can be given by—

Score S=aX+bY

where a and b are the predefined weightage factors for Static and Dynamic Score.

In accordance with an embodiment of the invention, the static scores are generated by the advertising system (in particular the advertising engine 515) and stores in influencer data repository 505 associated with influencer's profile. This score gets updated with time and is not calculated in real time. This score is generated on the basis of various identifiers and information provided in influencer's profile. Predefined rules have been set in advertising system to calculate scores for static identifiers.

The static identifiers include:

Endorsements Completed:

Greater the number of completed Advertisement, higher the score will be generated for any particular influencer. In this way, score X₁ is calculated and stored in influencer data repository.

Active Presence on Social Websites:

Score is generated after analyzing the number of social networking websites on which the influencer has presence. The advertising system also checks the time since when the influencer is present on social networking sites. The greater number of websites and longer the time duration, higher will be the score generated for any particular influencer. In this way, score X₂ is calculated.

Number of Followers/Fan/Friends:

If any influencer has large number of followers, friends or fans on different social networking websites, then high score will be generated for that influencer under this identifier. Thus, score X₃ is calculated.

Hiring Expenditure Cost:

The lower the hiring expenditure of the influencer, the higher will be the score generated for that particular influencer. Thus, Score X₄ is calculated.

Success Rate:

The success rate of influencer may be defined by the number of transactions generated through the advertisement done by that influencer. The higher the success rate, the higher the score will be generated. Thus, score X₅ is calculated.

Accordingly, these scores shall get updated in influencer's profile whenever any change happens in any identifiers values. For example, when an influencer gets a new advertisement assignment and completes the assignment then Score X₁ is updated automatically and stored in the influencer data repository associated with the influencer's profile.

Accordingly, the total static score may be calculated as:

Static Score X=a₁X₁+a₂X₂+a₃X₃+a₄X₄+a₅X₅

Where a₁, a₂, a₃, a₄, a₅ are predefined weightage factors stored in the advertising system.

In accordance with another embodiment of the invention, the dynamic scores are calculated in real time. Theses scores are also calculated on the basis of some fixed identifiers. However, for calculation of scores, information is required to be provided by brand owner and influencer. Dynamic scores are calculated in real time basis and vary for different brand advertisement assignments, thus the dynamic scores may be stored in any data repository on a temporary basis. These scores are calculated automatically by advertising system 500 (in particular the advertising engine 505) through analyzing the information provided by brand owner and influencer.

The dynamic identifiers include:

Location and Age:

The required information is provided by brand owners and thereon is compared with influencer's profile information. Upon the comparing, the score is generated on the basis of percentage of match. The higher the match percentage, higher will be the score generated. For example, if a brand owner require an influencer for his campaign whose age should be around of 40 and must be active in North America, then influencer with age 38 will be assigned more score then the influencer of age 56. Further, influencers whose are active in North America, North East and North-West of America will be assigned greater score than the influencers who are active in South East and South-West of America. In this way, the Location match score Y₁ and Age match score Y₂ are calculated.

Product Category Match:

This score is calculated after analyzing the match percentage between product category and area of work in which influencer is active. Higher score is assigned to that influencer who is active in the same area of in which the product category falls. Relatively low scores are generated for influencers whose are active in totally different area. For example, if there is an advertisement assignment of running shoes then highest score will be generated for an influencer who is an athlete. A relatively low score is generated for players active in indoor games. And even low score will be generated for any film star or television personality. In this way, score Y₃ is calculated.

Previous Association Between Brand and Influencer:

This Score is generated after deciding that the influencer had ever worked with a particular brand owner previously. The decision is made by the advertising system 500 only after analyzing the influencer's profile information and previous history stored in influencer data repository 505. The greater the number of previous engagements with brand owner, higher will be the score generated. In this way, score Y₄ is calculated.

Competitive Analysis:

This score is generated once the advertising system 500 decides the products category and check in influencer profile. The advertising system 500 may perform checks on whether the influencer ever worked in the same product category and if yes, than the advertising system further investigates that for one or more competitors. The lesser the number of assignments done for competitors, the greater will be the score generated for that particular influencer. Thus, Score Y₅ is calculated.

Accordingly, the total dynamic score may be calculated as:

Dynamic Score Y=b₁Y₁+b₂Y₂+b₃Y₃+b₄Y₄+b₅Y₅

where b₁, b₂, b₃, b₄, b₅ are predefined weightage factors stored in the advertising system.

Accordingly, the final score calculated is designated by S:

Final Score S=aX+bY

Accordingly, the above will be the score that shall be displayed in influencer's profile while influencer's profile will be appearing to brand owners, as recommendations or suggestions.

In accordance with another aspect of the invention, the advertising engine 515 is further configured to categorize each product or service into different categories of product or service such that each type of product or service is classified along with similar product or service. The advertising engine 515 is further configured to link the influencer-brand metric of the influencer with the each category of products or service such that the influencer-brand metric of the influencer for a category of products or service automatically updates depending upon the identifiers of respective influencer to estimate the appropriateness of the influencer for endorsing the category of products or service.

In accordance with another aspect of the invention, the advertising engine 515 selects a most appropriate influencer to endorse a particular product or service by generating an influencer-brand metric for each influencer and identifying a product or service being offered by a brand and a brand criterion associated with the product or services being offered. The advertising engine 515 further matches the brand criterion with the influencer-brand metric of each influencer among a group of influencer to estimate the influencer's awareness, appeal and relevance to a brand's image. Based on the matching, formulating an offer for the most appropriate influencer.

In accordance with another embodiment of the invention, the advertising engine 515 is configured to select the appropriate influencer on the basis of any of the identifiers depending upon the brand criterion. The brand criterion may be an influencer from a particular region or cast or sex or occupation or high social media presence or fixed price.

Further, the advertising engine 515 is further configured to formulate an offer for the selected influencer to endorse at least one product or service for the brand. The advertising engine 515 notifies the selected influencer of the offer and offers the selected influencer to endorse the product or service upon a successful approval from the influencer.

In another embodiment of the invention, the advertising engine 515 notifies the identified influencer on a mobile software application or ‘mobile app’ of the influencer device.

The offer data repository 520 is selectively in operative communication with the advertising engine 515 and the brand interface 525. The offer data repository 520 is configured to store the data relating to offers such as an influencer identifier, a product identifier, an offer identifier, a payment model and time period for endorsement. The data may be stored in the table format with the offer identifier being the primary key of the table. The offer data repository 520 may be a relational database in operative communication with the influencer data repository 505 and brand data repository 510.

The brand interface 525 is selectively in operative communication with the advertising engine 515 and brand 120 and configured to receive data from a user representing a brand or a server associated with the brand. The brand interface 525 further communicates with the brand 120 with regard to approval/refusal/negotiation of offers, payments, billing, notifications, etc.

The influencer interface 530, selectively in operative communication with the advertising engine and the influencer 110 and configured to transmit data to mobile software application on an influencer device.

The channel integration platform 535 is selectively in operative communication with the advertising engine 515 and configured to perform security related and data integrity related checks on the content of the data. The Channel Integration Platform 535 may include a security protocol that performs security related and data integrity related checks on the data files. The security protocol may be SSL (Secure Socket Layer), TLS (Transport Layer Security), PPP (Point-to-Point protocol) or any other protocol known in the art.

The registration module 540 is selectively in operative communication with the influencer interface 530 and brand interface 525 and configured for registering one or more influencers and one or more brands.

The influencer content module 545 is selectively in operative communication with the influencer interface 530 and configured to provide a mobile software application and contents customized for the influencers to download as an influencer application on the influencer device.

The brand content module 550 is selectively in operative communication with the brand interface 525 and configured to provide the brand interface 525 with customized contents for proposing and managing offer to influencers.

The reconciliation module 555 is selectively in operative communication with the advertising engine 515 and operable to effect a payment transaction between the influencer 110 and a brand 120. The reconciliation module 555 imposes a settlement commission to the brand for providing an offer to the influencer using the advertising system 300.

The tracking module 560 is selectively in operative communication with the advertising engine 515 and configured to track the influencer posts or tweets on the internet or social networking website and further configured to track the likes, clicks, leads or transactions of the target audience that follow the influencer tweet or posts such that the payment estimation is accurate between the brand owner and influencer.

The admin platform 565 is selectively in operative communication with the advertising engine 515 and enables the platform administrator to view, activate, deactivate, etc. influencers and brands registered within the advertising system 500. The admin platform 565 may also view different analytics and reports to analyze business.

In accordance with an embodiment of the invention, the influencer is an influential person having the ability to endorse or market a brand's product or services. The influencer may be a sports person, an entertainer or a well-known individual. In a preferred embodiment, the influencer is a celebrity.

In accordance with another embodiment of the invention, the payment model is Pay Per Tweet, Pay Per Click, Pay Per Lead and Pay Per Transaction. The above mentioned models are considered payment models for the influencer and brand. However, may be considered advertising models for the prospective customers or target audience. The advertising engine keeps a track of influencer post or tweet on the internet or social networking website and also keeps a track of the likes, clicks, leads or transactions of the target audience that follow the influencer tweet or posts such that the payment estimation is accurate between the brand owner and influencer.

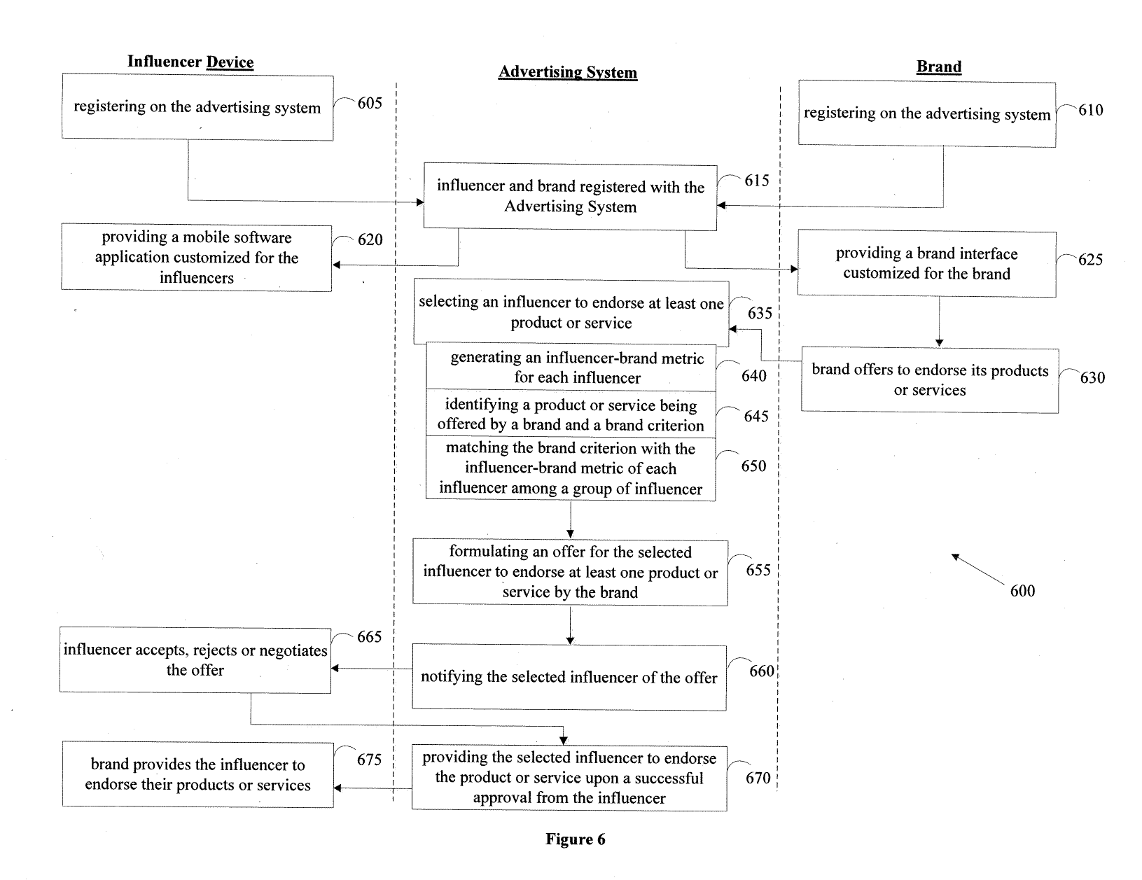

FIG. 6 illustrates a flowchart showing a method for automatically selecting an influencer suitable for endorsement of a product or service over advertising system in accordance with the second embodiment of the present invention.

The method comprises the steps of registering one or more influencers and one or more brands on the advertising system, as shown by step 605 and 610. The influencers may register on the ‘mobile app’ available of the web or can directly register with the advertising system. The brand may register directly on the advertising system 300.

The method further comprises of the advertising system registering the influencers and brands as shown by step 615. Further, the method provides a mobile software application customized for the influencers as an influencer application to be installed on an influencer device, as shown by step 620. This is only the case if the influencer does not possess the influencer application on their device.

Further, the method provides a brand interface customized for the brand to propose and manage offer to influencers, as shown by step 625. The brand interface may be a web platform available on the web which integrates the brand with the advertising system 300.

Further, the brand prepares an offer to endorse the products or services as shown by step 630. The brand transfer control over to the advertising system to select, offer and negotiate with the influencers on his behalf.

Further, the advertising system selects an influencer to endorse at least one product or service by an influencer-brand metric, as shown by step 635. The influencer-brand metric comprises a plurality of identifiers to automatically evaluate an influencer's awareness, appeal and relevance to a brand's image and their influence on consumer buying behavior.

In accordance with another embodiment of the invention, the influencer-brand metric comprises of a plurality of static identifiers and a plurality of dynamic identifiers, with both defining a score for an influencer suitable for endorsing a brand's product or service.

In accordance with another embodiment of the invention, the static identifiers include one or more of the following identifiers: endorsements completed, active presence on social websites, number of followers/fan/friends, hiring expenditure cost and success rate.

In accordance with another embodiment of the invention, the dynamic identifiers include one or more of the following identifiers: location, age, product category match, previous association between brand and influencer and competitive analysis score.

Further, the selecting process comprises of generating an influencer-brand metric for each influencer and identifying a product or service being offered by a brand and a brand criterion associated with the product or services being offered, as shown by step 640 and 645.

Step 650 shows matching the brand criterion with the influencer-brand metric of each influencer among a group of influencer to estimate the influencer's awareness, appeal and relevance to a brand's image. On the basis on matching, formulating an offer for the most appropriate influencer to endorse at least one product or service by the brand, as shown by step 655. The offer is prepared on the line of the instructions received from the brand owner. The offer comprises of an influencer identifier, a product identifier, a payment model and time period for endorsement.

In accordance with an embodiment of the invention, the selecting step further includes selecting the appropriate influencer on the basis of any of the identifiers depending upon the brand criterion.

Further, the advertising system notifies the selected influencer of the offer, as shown by step 660. The advertising system notifies the identified influencer on the mobile software application of the influencer device.

Further, the influencer may accept/refuse/negotiate the offer presented by the brand, as shown by step 665. The influencer may negotiate or refuse the offer for endorsing the brand's product or service with regards to the payment model or time period.

Further, the advertising system provides the selected influencer to endorse the product or service upon a successful approval from the influencer, as shown by step 670 and 675.

In accordance with an embodiment of the invention, the payment model is Pay Per Tweet, Pay Per Lead and Pay Per Transaction. In accordance with another embodiment of the invention, the advertising system charges the brand for providing an offer to the influencer on the advertising system.

In accordance with an embodiment of the invention, the method further comprises of categorizing each product or service into different categories of product or service such that each type of product or service is classified along with similar product or service.

In accordance with an embodiment of the invention, the method further comprising linking the influencer-brand metric of the influencer with the each category of product or service such that the influencer-brand metric of the influencer for a category of products or service automatically updates depending upon the identifiers of respective influencer to estimate the appropriateness of the influencer for endorsing the category of product or service.

A computer program for automatically selecting an influencer suitable for endorsement of a product or service is disclosed. The computer program comprises of code means which when run on an advertising system, causes the advertising system to select an influencer to endorse at least one product or service by a influencer-brand metric; the influencer-brand metric comprises a plurality of identifiers to automatically evaluate a influencer's awareness, appeal and relevance to a brand's image and their influence on consumer buying behavior and formulate an offer to the selected influencer to endorse at least one product or service for the brand; the offer comprises of an influencer identifier, a product identifier, a payment model and time period for endorsement.

A computer program product is also disclosed. The computer program product comprises of a computer readable code means and a computer program as described above.

Further, the phrase ‘mobile app’ and ‘mobile software application’ have been used interchangeably through the specification and actually relate to the same denotation. Further, the phrase ‘endorsements’ and ‘advertisements’ have also been used interchangeably.

The advertising system, as disclosed above, provides for:

Finding Influencers

The advertising system enables a brand to select the social media influences (celebrities) which are on the top of the food chain while influencing purchasing decision of the customers. The advertising system finds a way to connect the brands with a plurality of influencers at the same time.

Influencer Engagement and Promotion

The advertising system enables the influencers to endorse brands but not promote individual products or services. The advertising system enables the influencers to work on a gain share model rather than a fixed fee.

Post Engagement Tracking

The advertising system tracks the performance of the influencers on the social media. The advertising engine tracks the influencer posts or tweets on the social networking media and further tracks the likes, clicks, leads or transactions of the target audience that follow the influencer tweet or posts such that the payment estimation is accurate between the brand owner and influencer.

Ease and Convenience

The advertising system provides a common platform which brings everything together i.e., brands and influencers.

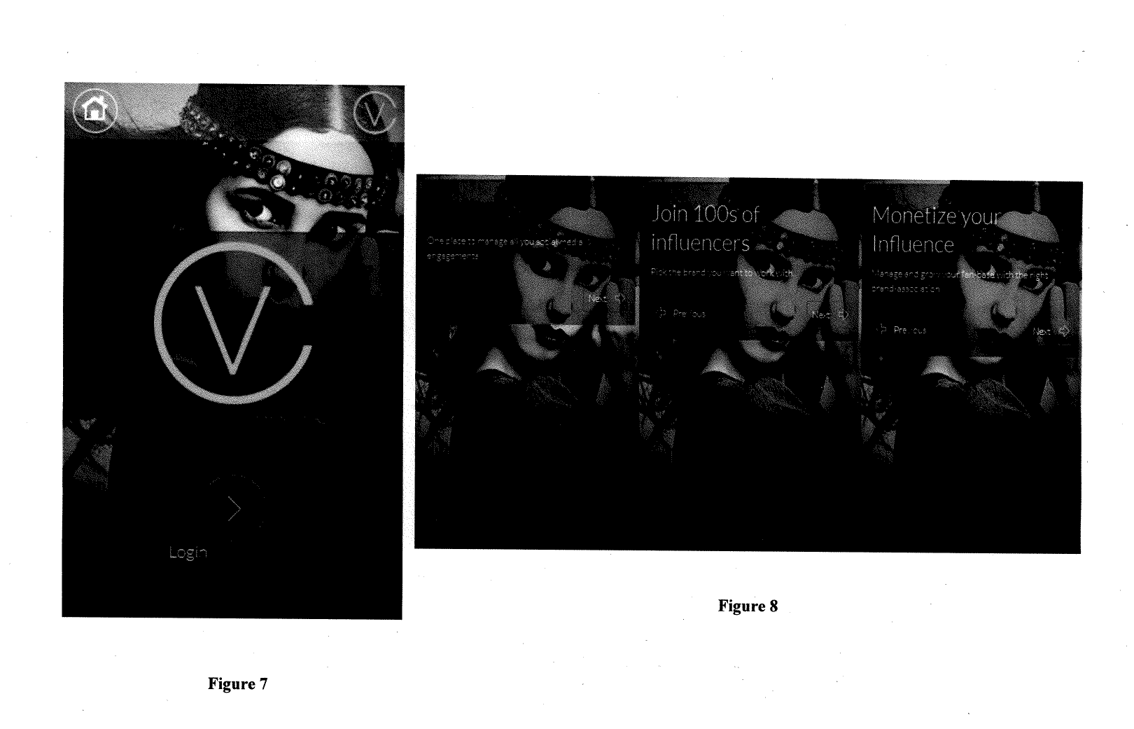

FIG. 7 illustrates a screenshot of the home page of the mobile app in accordance with an embodiment of the present invention. This screenshot is particularly shown for smart mobile devices. Similar view would be shown if mobile software application or mobile app is being used on tablets, laptops or any other portable communication medium. Mobile software application will be launched upon providing input by finger touch or any other input means. This application will be used and managed by influencer, thus human image shown in FIG. 7 may be the image of influencer itself. Mobile software application is associated with the data repositories of the advertising system 300. Any data entered into mobile software application will be stored in the database of the advertising system 300.

FIG. 8 illustrates a screenshot of the welcome pages of the mobile app in accordance with an embodiment of the present invention. These pages may be navigated by touch input or any other suitable input medium and describes about particular features of the mobile software application. For example, one of the welcome pages of mobile software application allows influencer choose any brand among of available ones. Another welcome page as shown in FIG. 8, allows the influencer to manage his fan base which is followers of the influencer.

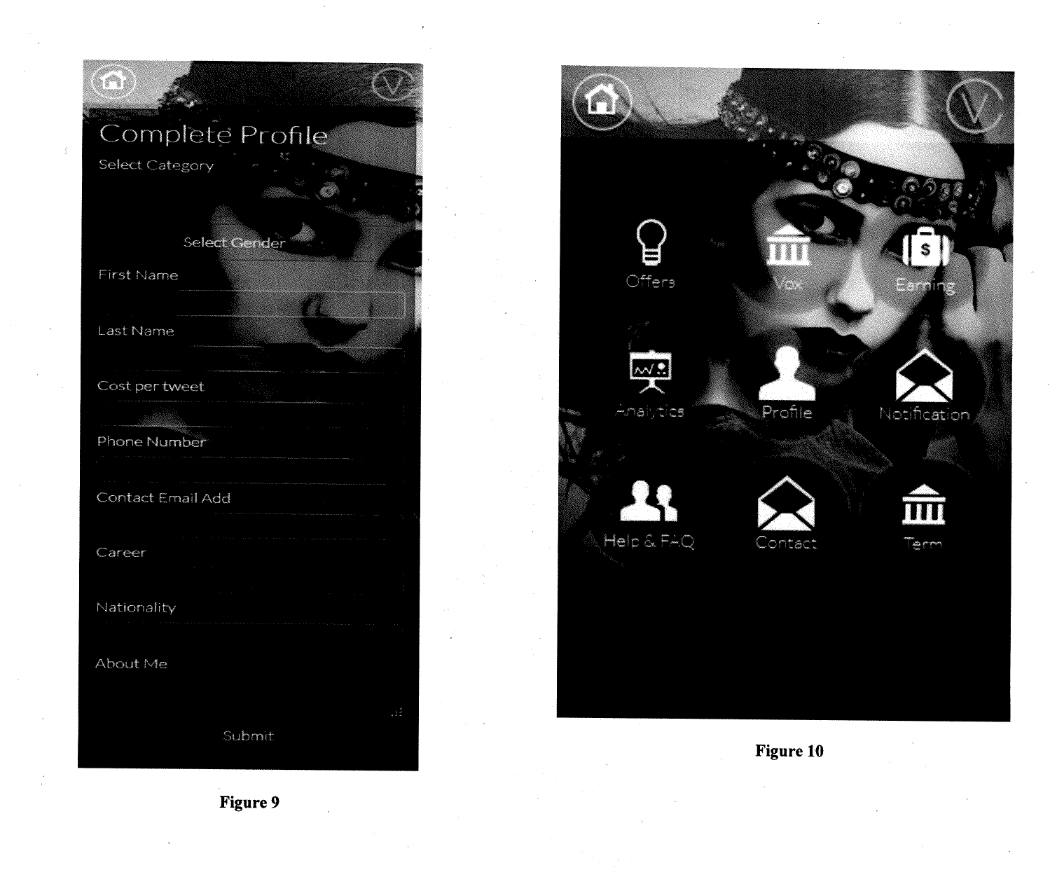

FIG. 9 illustrates a screenshot of the registration process in accordance with an embodiment of the present invention. The registration page allows the influencer to fill the personal and other information to build his/her profile. Information may be entered by finger touch or any other input medium. Information inputted in this page is saved in influencer data repository 305 of the advertising system 300, associated with the mobile software application. The text boxes as shown in the figure are not a limiting factor. Any additional information boxes may be added later by the mobile software application developer or administrator.

FIG. 10 illustrates a screenshot of the menu page of the mobile app in accordance with an embodiment of the present invention. The menu page allows the influencer to operate and manage all the operational feature of mobile software application. The menu comprises of a plurality of icons which on being pressed launch or perform the predefined feature. For example, the influencer may go to home page or check and edit the profile by clicking the home icon and profile icon respectively. The influencer may also check their earning and notification from the earning and notification icons respectively.

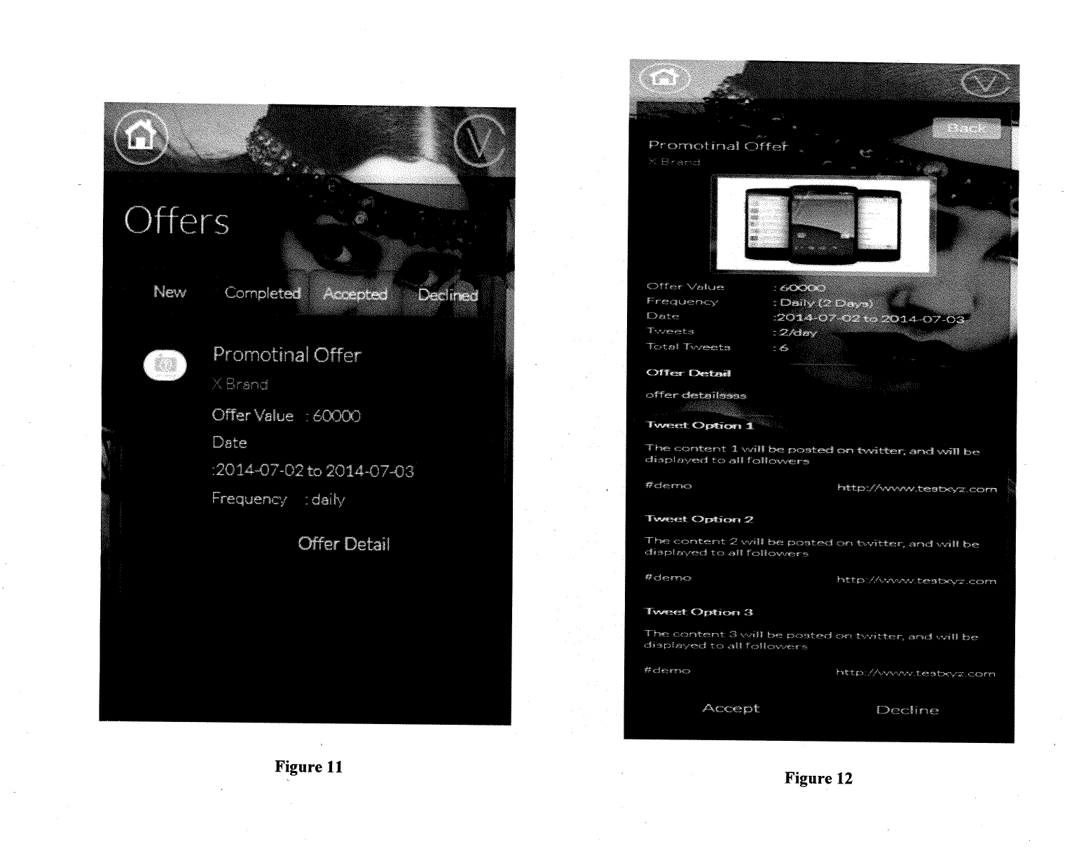

FIG. 11 illustrates a screenshot of a page of the mobile app showing new offers to influencer in accordance with an embodiment of the present invention. The page depicts a brand offering statistics. The page shows the influencer that a brand is offering him an offer for endorsement and other details with regards to the endorsements such as offer value and time period. Under the various other tabs provided on the page, the influencer may also check the previous completed accepted or declined endorsement offers, thus being able to view his/her complete brand offering statistics. Another tab, Offer Details provided on the bottom of the page allows the influencer to view more details about brand offering.

FIG. 12 illustrates a screenshot of a page of the mobile app showing offer details for the new offer in accordance with an embodiment of the present invention. The page provides the influencer to check and evaluate the details of endorsements provided by the brand. Influencers may navigate to this page by clicking the Offer Details tab shown in FIG. 11. This page provides the influencer, more precise information about the Brand offering like mode of payment, mode of advertising, frequency of advertising, time period of Advertisement and other details. For example, the mode of advertisement or endorsements is ‘tweets’ by influencer and frequency of advertisement is on daily basis. By clicking on Accept or Decline tab, the influencer may accept or reject the offers.

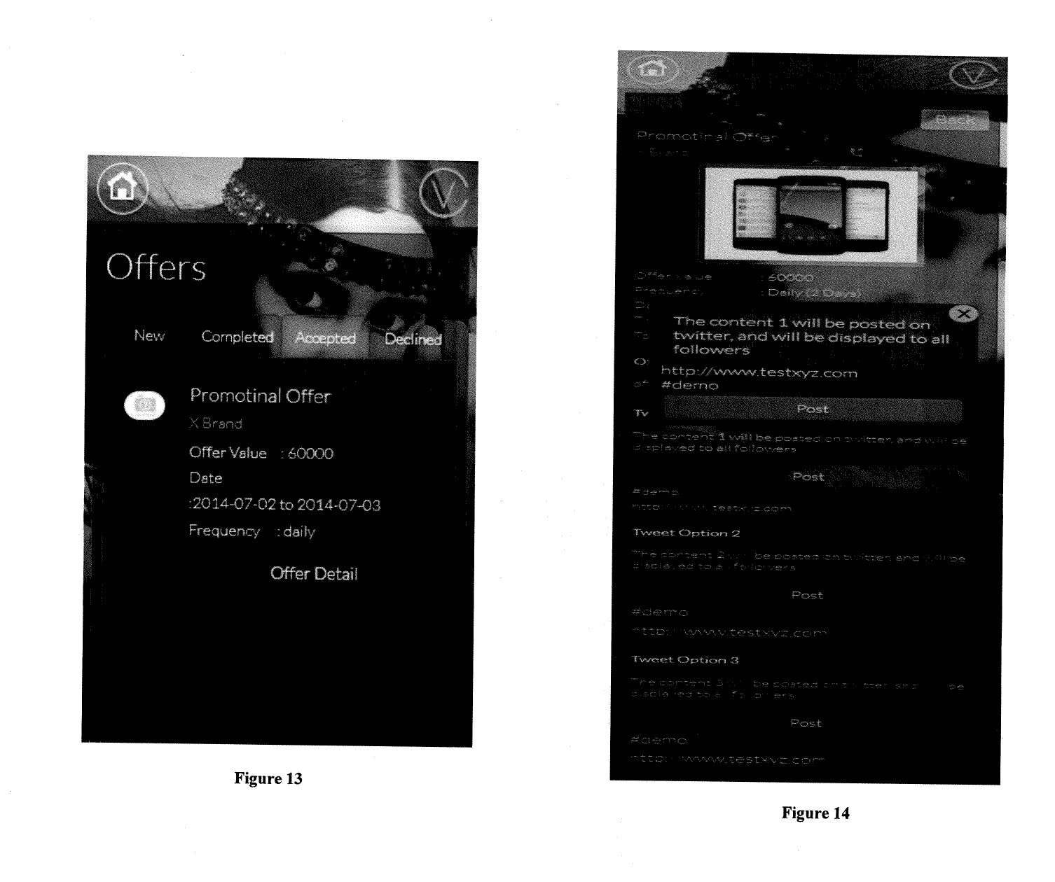

FIG. 13 illustrates a screenshot of a page of the mobile app showing accepted offers by influencer in accordance with an embodiment of the present invention. This page allows the influencer to see/check the advertisement offers which are accepted by the influencer. An extra tab Offer Detail is provided to know more about that particular advertisement offer accepted by influencer.

FIG. 14 illustrates a screenshot of a page of the mobile app showing the influencer executing the offer on social media in accordance with an embodiment of the present invention. The page is displayed when influencer clicks the Offer Details tab provided on the page showing accepted offers, as shown in FIG. 13. The page allows the influencer to check the details in more depth. Also, an additional removable page telling about the advertisement mode pops up on the page upon a pre-defined influencer action.

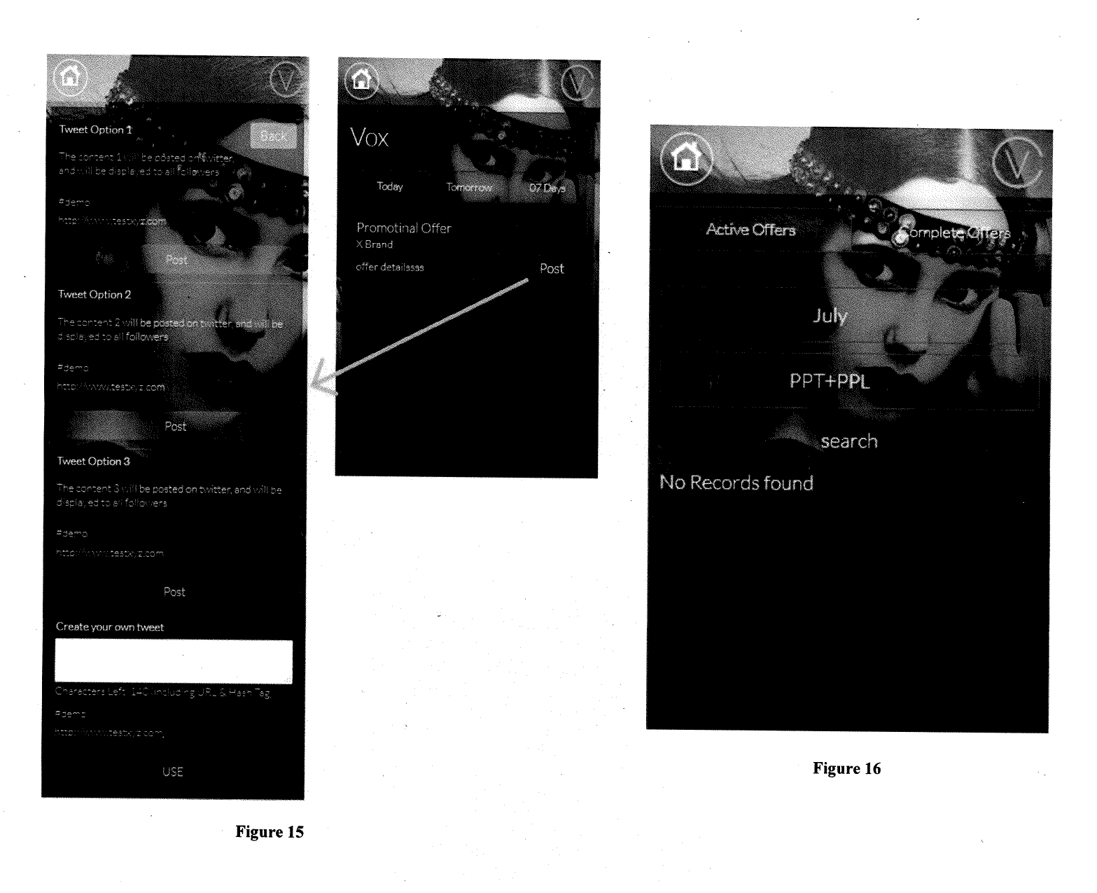

FIG. 15 illustrates a screenshot of a page of the mobile app showing the offers of today that the influencer has to execute in accordance with an embodiment of the present invention. The page displays a work schedule for an influencer. The influencer may check which advertisement assignment is to be completed today and in which way. For example, as in case of FIG. 15, the influencer has to post more than one tweets which may be seen by all his/her followers. This page also provides the option to influencer to create his/her own tweets. Influencers may also check the advertisement schedule for tomorrow and for remaining engager time period through this page of mobile software application.

FIG. 16 illustrates a screenshot of a page of the mobile app showing the earning of the influencer from the current deals in accordance with an embodiment of the present invention. The page depicts the earning from the all active advertising assignments for the influencer. Influencer may also check the statistics of completed advertisement offers by clicking on the Complete Offers tab provide on the same page. If there are too many active offers than influencer may also search about any specific advertisement offer by inputting in search textbox provided on the page.

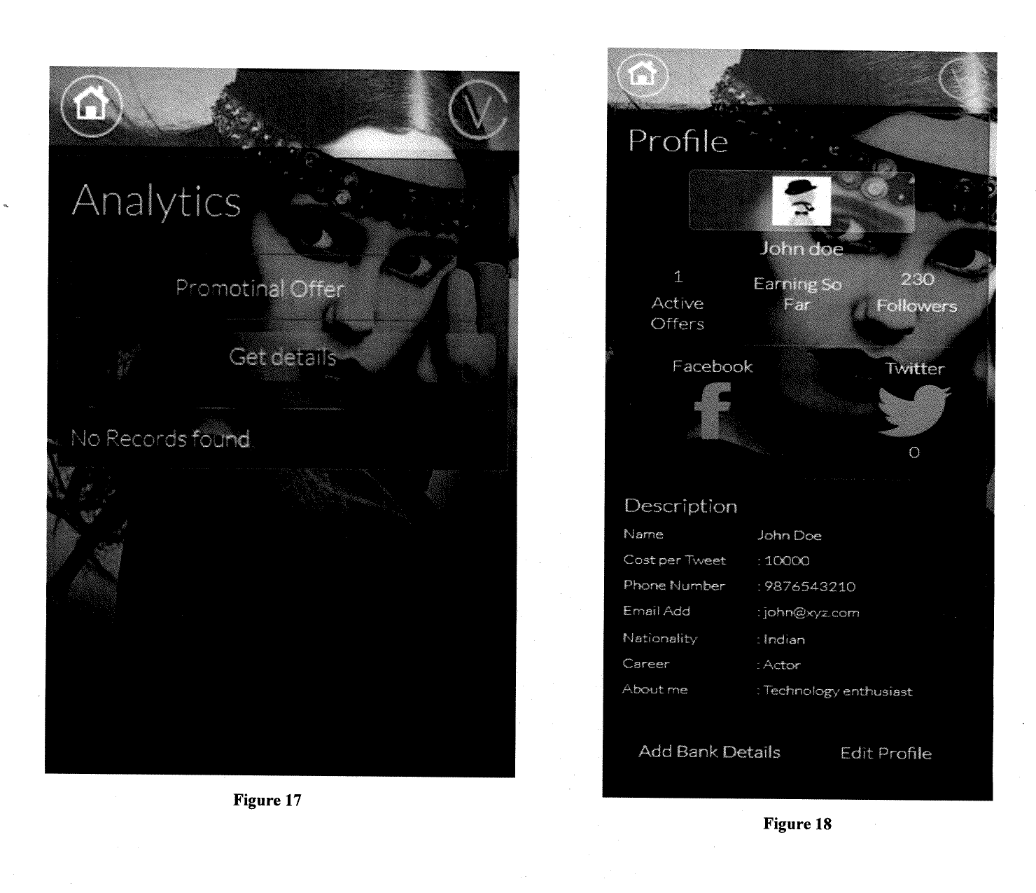

FIG. 17 illustrates a screenshot of a page of the mobile app showing the influencer analytics in accordance with an embodiment of the present invention. The page allows the influencer to obtain more in-depth details of all the advertisement offers.

FIG. 18 illustrates a screenshot of a page of the mobile app showing the influencer profile in accordance with an embodiment of the present invention. The page shows the profile information of the influencer including his name, contact details, profession, cost to advertisement assignments, number of followers, the influencer followers on social networking sites, total earnings through advertising projects and other analytics information. The page also allows the influencer to add banking details by clicking Add Bank Details tab. The influencer may also edit their profile by clicking Edit Profile tab provided on this page.

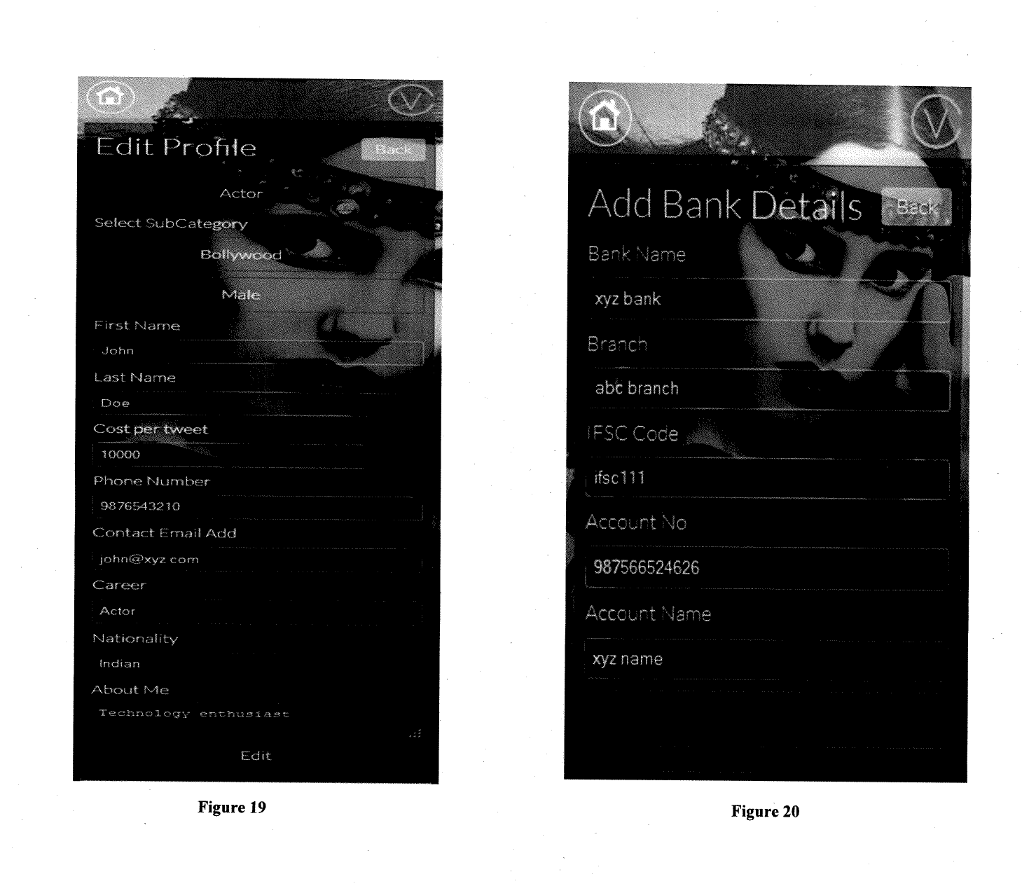

FIG. 19 illustrates a screenshot of a page of the mobile app showing the editing of an influencer profile in accordance with an embodiment of the present invention. The page allows the influencer to add extra information and change or edit the information provided previously. At any time while editing the profile, the influencer may go back to the previous page by clicking on Back tab provided on top right of the page.

FIG. 20 illustrates a screenshot of page of the mobile app showing adding bank details of the influencer in accordance with an embodiment of the present invention. The page allows the influencer to enter the bank details by inputting information into text boxes provided by the mobile app and by clicking submit button the data gets stored in the influencer data repository 305 of the advertising system 300. The bank details includes name of bank, account number and other banking related information.

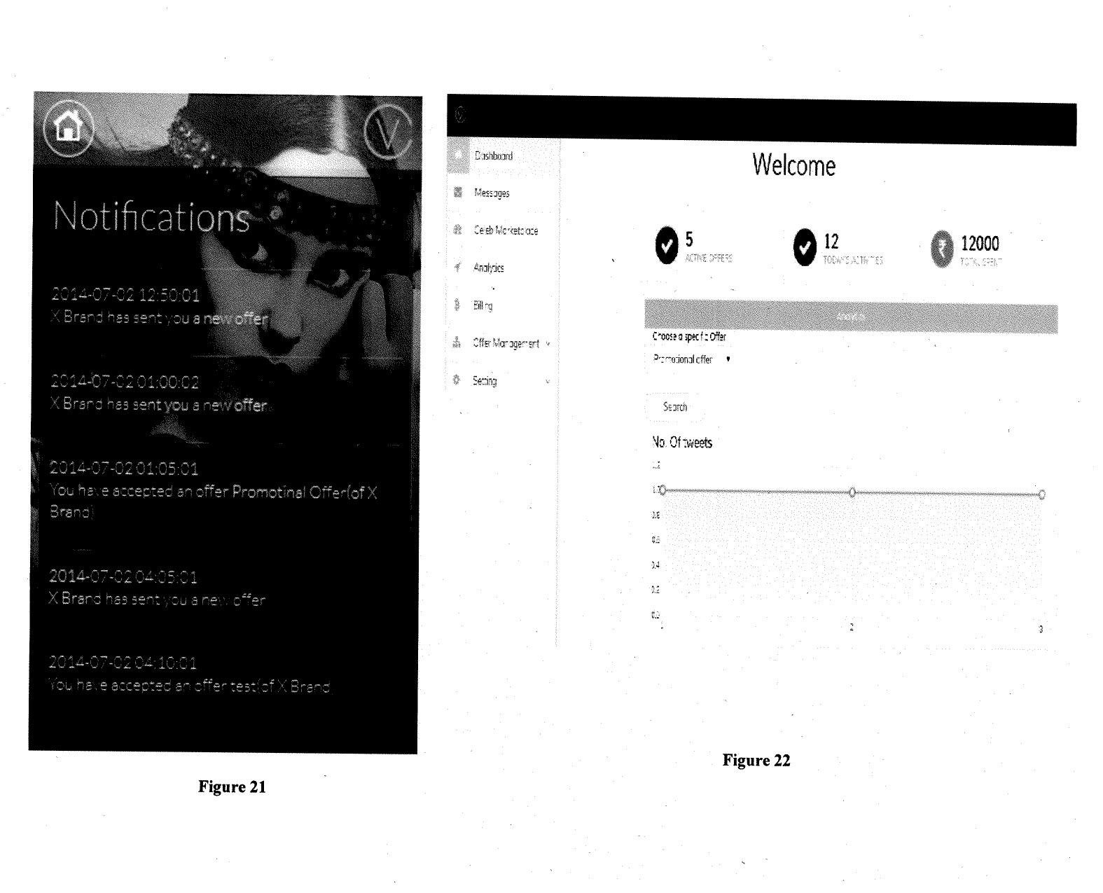

FIG. 21 illustrates a page of the mobile app showing the influencer notifications in accordance with an embodiment of the present invention. The page depicts a very important feature of the mobile app i.e., notifications. All the activities related to brand offering of advertisement offers are shown in this page as notifications, including new advertisement offers and accepted offers. Notification information are shown in this page also includes exact date and time when the advertisement proposal is offered or accepted. Thus, the influencer may get the advertisement offer information while on the go without digging deep into his profile

FIG. 22 illustrates a screenshot of a page of the brand interface showing the dashboard for brands in accordance with an embodiment of the present invention. Brand interface is used by the brand owner to manage their advertisement campaigns. FIG. 22 shows the brand interface's page that includes various tabs to navigate such as Dashboard, Messages, Influencer Management, Analytics, Billing, Offer Management and Setting tabs. Brand Interface is also connected with a brand data repository 320 of the advertising system 300. The home page of brand interface shows a brief snapshot of brand owner's profile that is registered with the advertising system. For example, the case shown in the FIG. 22, the brand owner has total 5 active offers means brand owner has 5 advertisement assignments for engagement with any influencer or in search of influencer. The total expenditure of the brand owner till date is also displayed in the home page of brand interface. Brand Interface is a simple web based interface which can be accessed from any computer, laptop, notebook, tablet or any other similar computing devices.

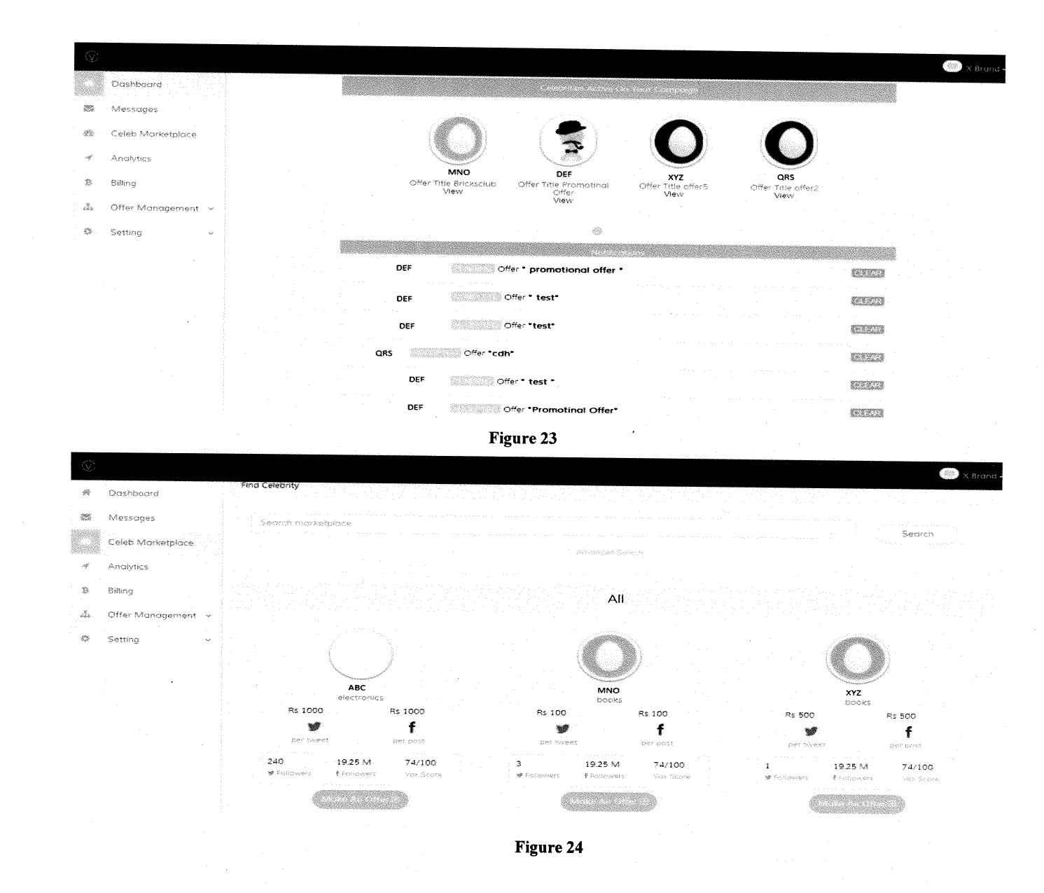

FIG. 23 illustrates a screenshot of a page of the brand interface showing the influencer marketplace having details of all the influencers in accordance with an embodiment of the present invention. The page is rendered by advertising system when brand owner click the Celeb Marketplace tab provided on home page of brand interface. Celeb Marketplace is a section which contains the record of all the influencers registered with the advertising system. Brand owners may see all the influencers with their profile snapshots including their social networking statistics, charges and most importantly their score generated by advertising system. For example, in the case shown in FIG. 23, there are three influencers showing in the celeb marketplace section. The number of influencers showing is not a limiting factor. Any number of influencers registered with the advertising system may be shown in the Celeb Marketplace section.

FIG. 24 illustrates a screenshot of a page of the brand interface showing the active influencers for a brand in accordance with an embodiment of the present invention. The page shows the influencers who are somehow associated with the brand owner in brand owner's campaign. The page is rendered by the advertising system after clicking on Dashboard tab provided on the homepage of brand interface. Active influencers in dashboard include influencers who were offered an advertisement offer by the Brand Owners and accepted it and those influencers who were offered an advertisement assignment and they declined or had not answered till the date. For example, in the case shown in FIG. 24, QRS is an influencer who had accepted the advertising offer made to him by brand owner while influencer DEF has still not accepted the offer made to him by the brand owner.

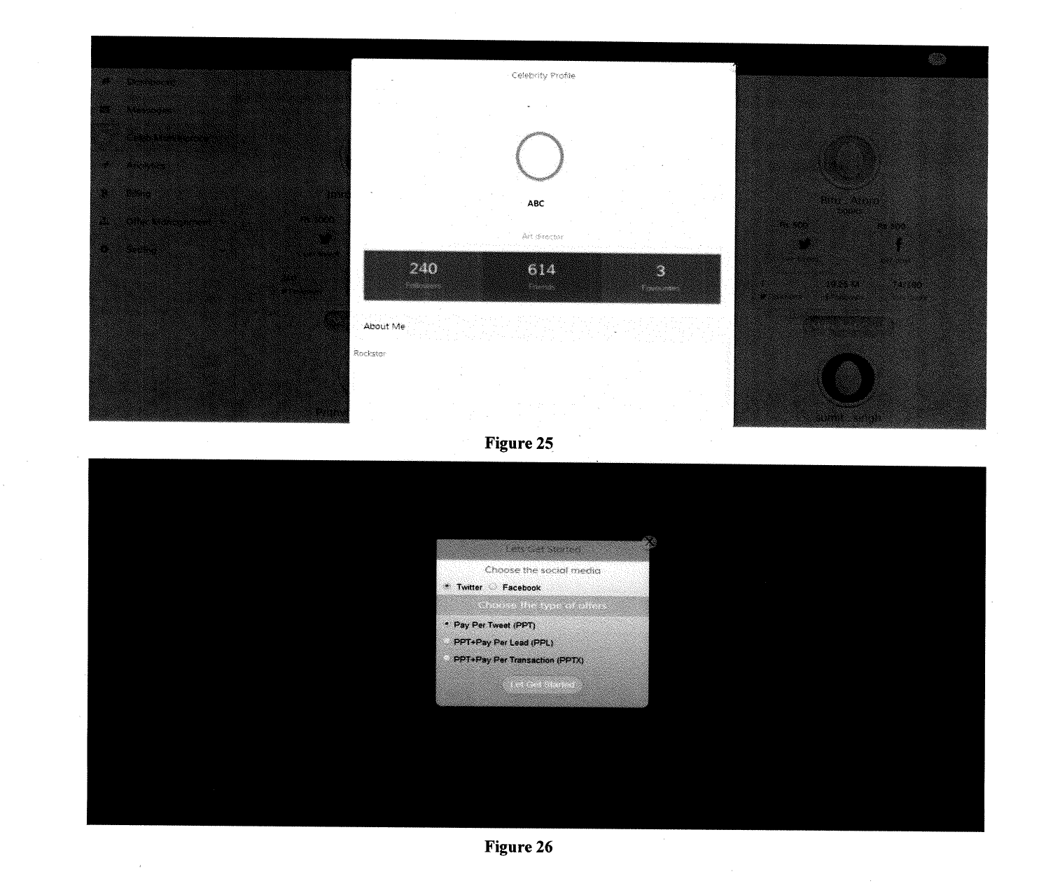

FIG. 25 illustrates a screenshot of a page of the brand interface showing an influencer profile in accordance with an embodiment of the present invention. The page shows detail information of any influencer chosen by the brand owner. Influencer's information may be obtained by clicking on his icon showing in either Celeb Marketplace or in Dashboard section. Influencer's information may include his friends and followers on social networking sites, profession and bio-information. According to an embodiment, the information shown in the in FIG. 25 should not be considered as limiting factor.

FIG. 26 illustrates a screenshot of a page of the brand interface showing making an offer by selecting the social medium and offer payment type in accordance with an embodiment of the present invention. This page shows means of offering advertisement proposal to influencer by the brand owners. This page determines a process for brand owners to run their advertising campaigns. This is performed just before approaching the influencer for advertising proposal or advertising campaign or endorsements. Brand owners may select from the available social networking sites on which brand owners wants to run their advertising campaign. Further, payment modes may be selected by choosing from the available options. For example, in case shown in the FIG. 26, the payments may be done by Pay Per Tweet (PPT), PPT+Pay Per Lead (PPL) or PPT+Pay Per Transaction (PPTr).

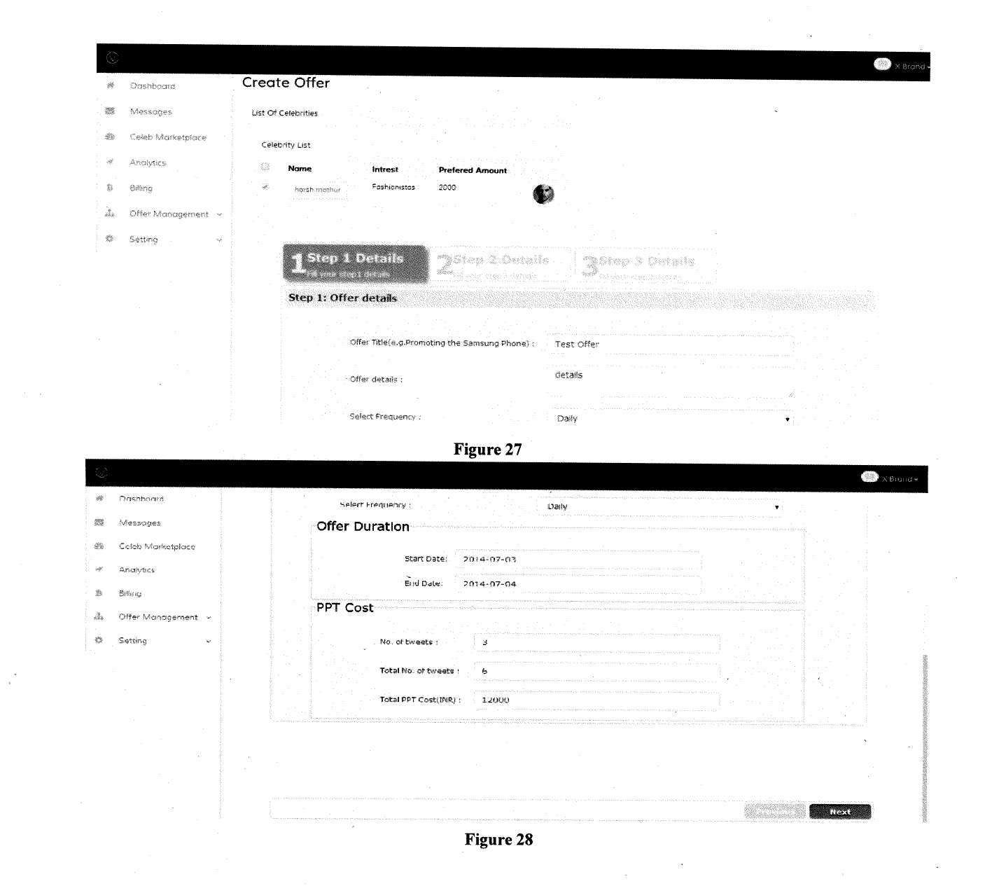

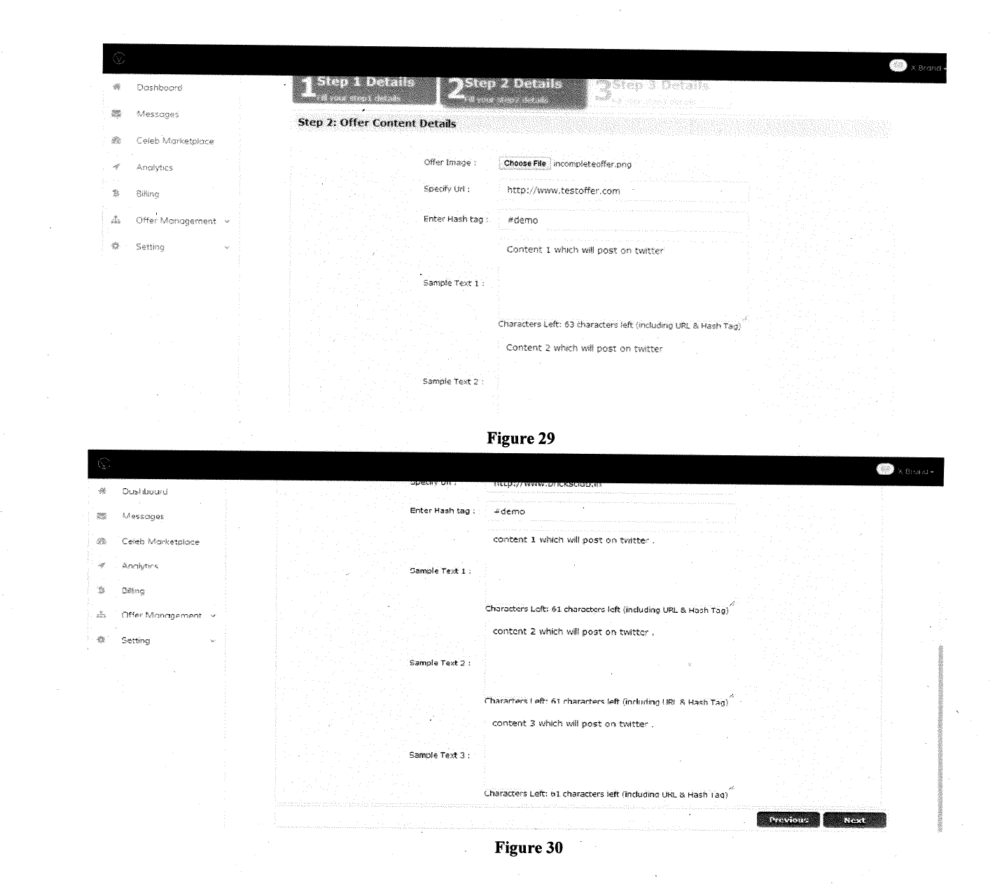

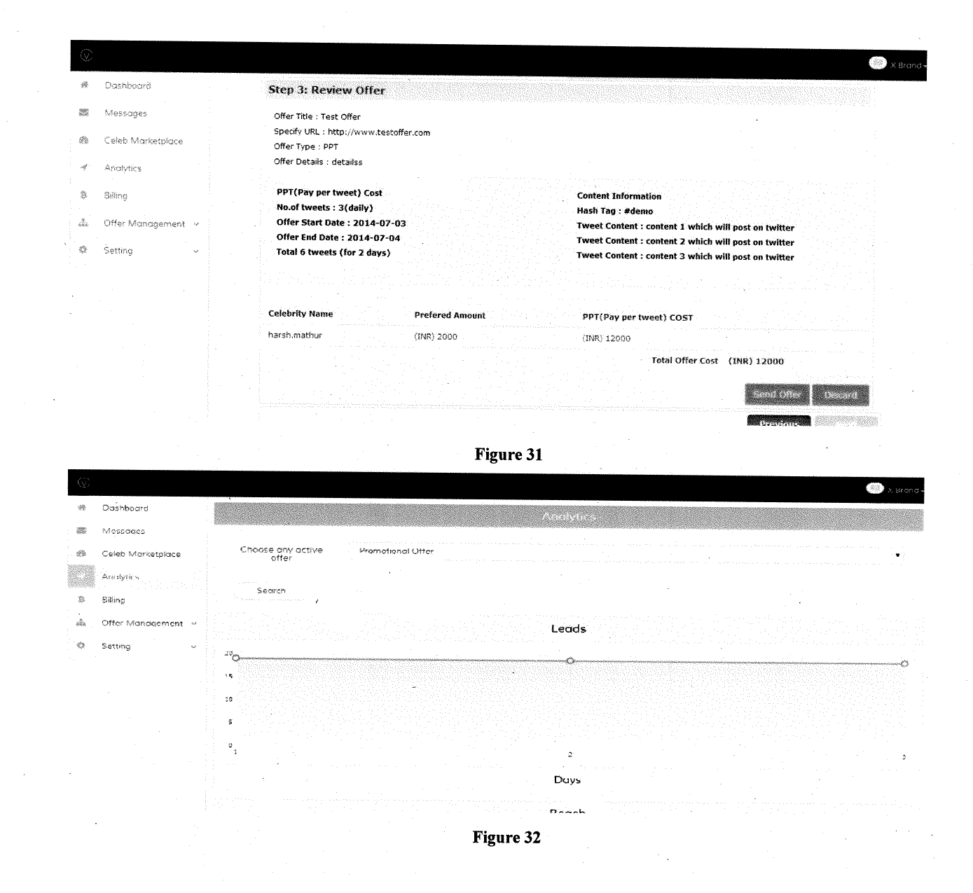

FIGS. 27, 28, 29, 30 and 31 of the present disclosure shows various steps (1, 2 and 3) to be followed during approaching the influencer for advertising campaign. The whole process is performed in three steps. FIG. 27 and FIG. 28 depicts the first step of the process in which an influencer is first selected and brief information about advertisement proposal is provided. Brand interface page shown in FIG. 27 and FIG. 28 contains text boxes such as Offer Title, Offer Detail, Frequency, Offer Duration and PPT Cost. In these text boxes, the brand owners provide the relevant information. Next step as shown in FIG. 29 and FIG. 30, contains more text boxes where again brand owners provides the relevant information. These pages gather more depth information about the advertisement proposal like which portion of Advertisement will be posted on which social networking site. Next step as shown in FIG. 31 provides the feature of final review of advertisement proposals made by brand owners before sending to the selected influencer. Brand owners may discard the advertisement proposal if they observe any mistake in the offer made or due to any other reason appropriate to discard the offer.

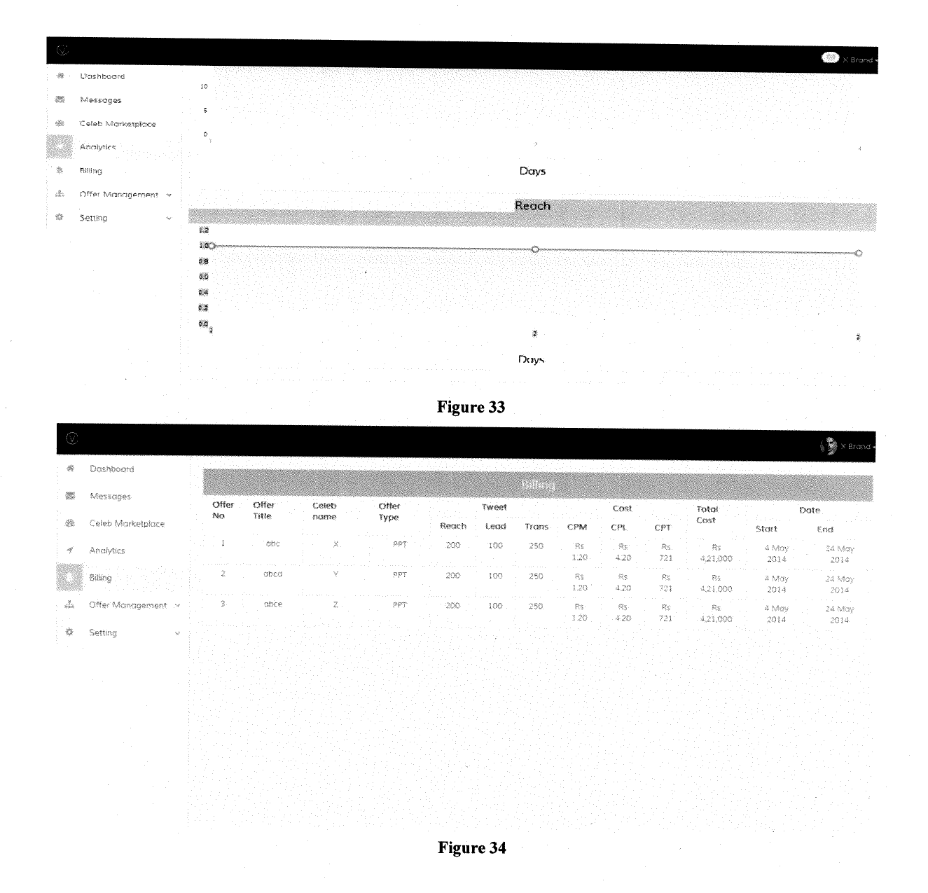

FIGS. 32 and 33 illustrates a screenshot of a page of the brand interface showing the analytics of the brand in accordance with an embodiment of the present invention. These pages depict analytics about the advertisement campaigns made by Brand owners. Brand owners may perform a search for their advertising campaigns in the search box provided in the analytics page. This page is rendered by the advertising system when brand owners click on the Analytics tab provided on the home page of brand interface.

FIG. 34 illustrates a screenshot of a page of the brand interface showing the billings of the brand in accordance with an embodiment of the present invention. This page allows the brand owners to check their expenses over their advertising campaigns. The advertising system may navigate to this page once brand owner clicks on the Billing tab, provided on the home page of brand interface. Billing Page shows in-depth analysis of total billing expenses in a tabular manner. Brand owners may get an estimate on the total amount of spending on influencer advertising campaigns. Also, the number of tweets, lead and transaction generated by influencer is also displayed in the same table showing billing expenses.

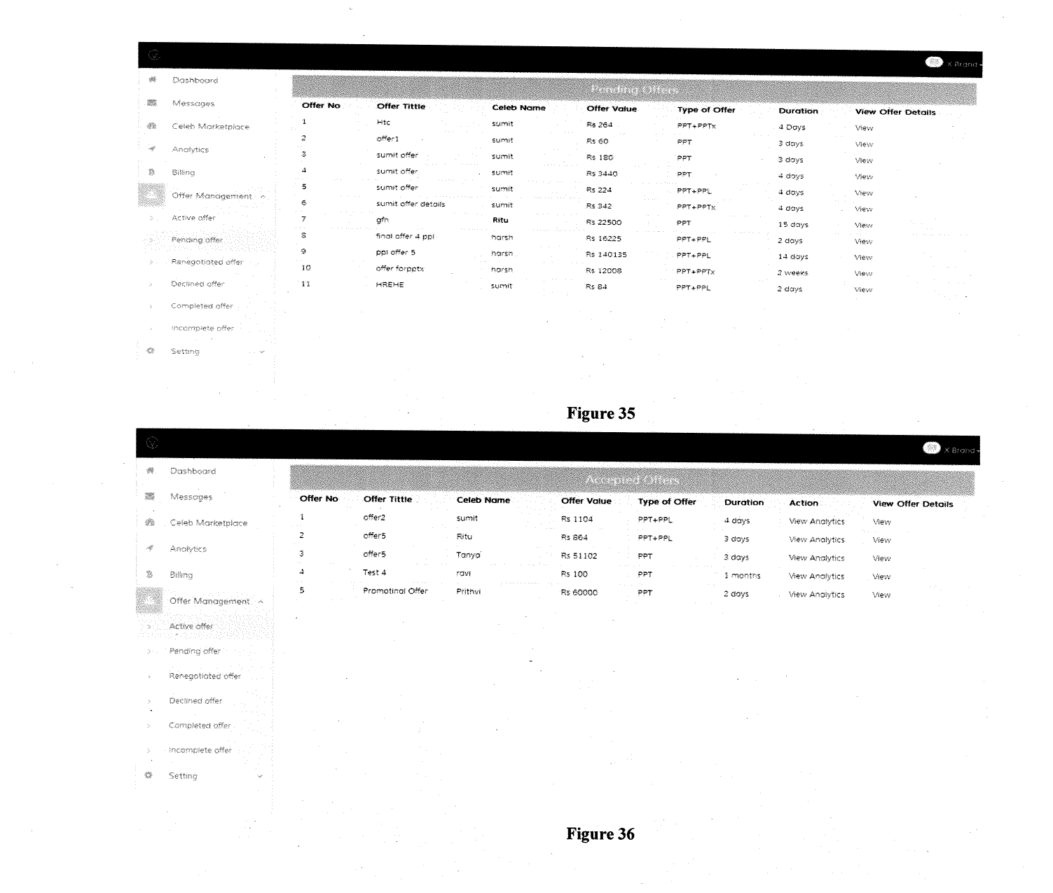

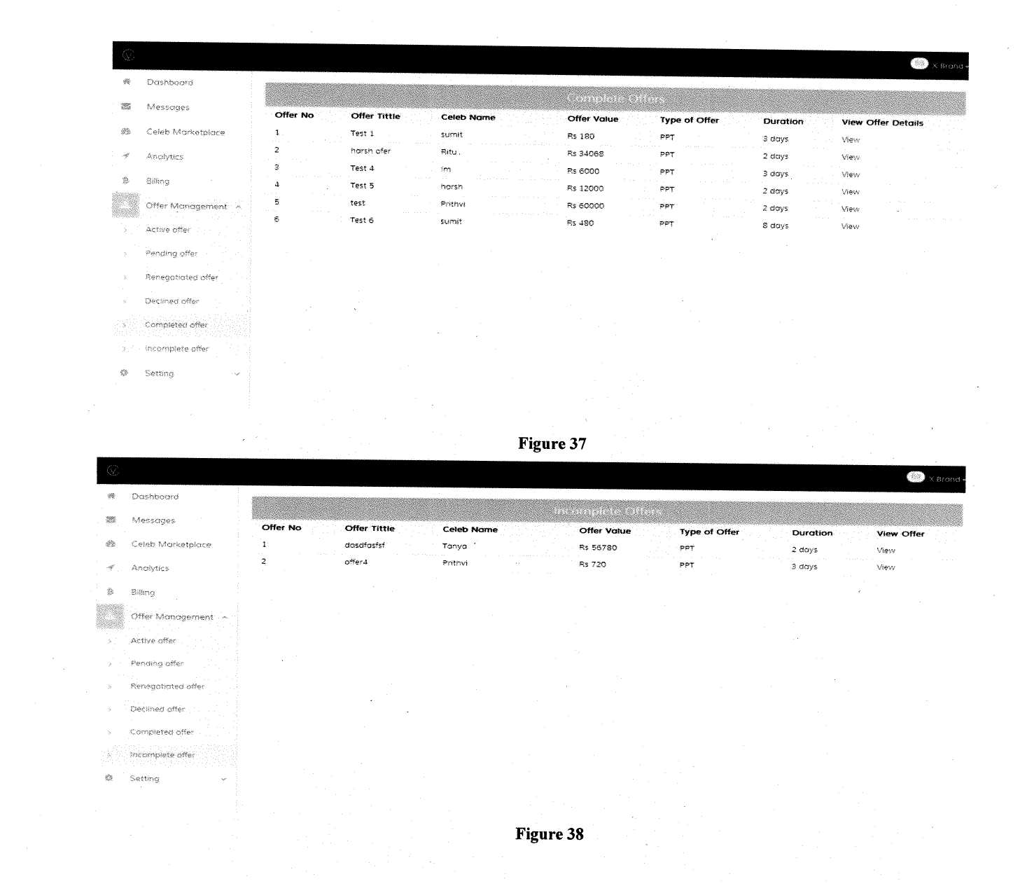

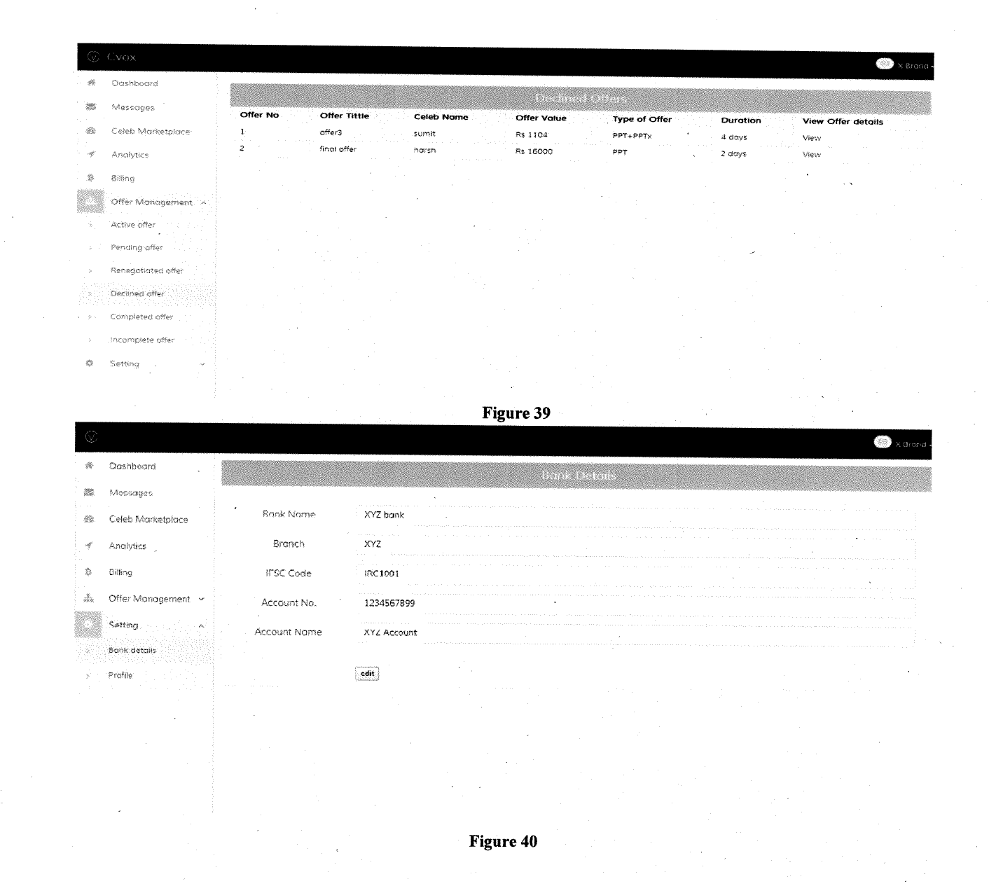

FIGS. 35 to 39 illustrates screenshots of a page of the brand interface showing the offer management section of brand interface in accordance with an embodiment of the present invention. The offer management section represents an important section of brand interface and may contain many sub section tabs under it. On clicking at Offer Management tab provided on the homepage of brand interface, the tab expands into various sub sections. Theses sub sections are Active Offer, Pending Offer, Renegotiated Offer, Declined Offer, Completed Offer and Incomplete Offer, as shown in lower pane of the interface.

FIG. 35 shows in particular, the tabular analysis for those advertisement offers made by brand owners which are still not confirmed by influencers. These offers come under the section of pending offers. Detail tabular analysis of pending offers shows information about pending offers like offer title, influencer name, value, duration and type of offers.

FIG. 36 of the present disclosure shows Active Offer section under the Offer Management tab. This page shows the tabular analysis of advertisement offers made by brand owners which are still active. Tabular representation of active offer statistic shows the information of active offers like offer title, selected influencer, offer name, value, duration and a detail analysis section. In the same way details analysis of Complete Offers, Incomplete Offers and Declined Offers, represented in tabular manner may be obtained. FIGS. 37, 38 and 39 of the present disclosure shows the pages representing tabular analysis of Complete Offers, Incomplete Offers and Declined Offers respectively.

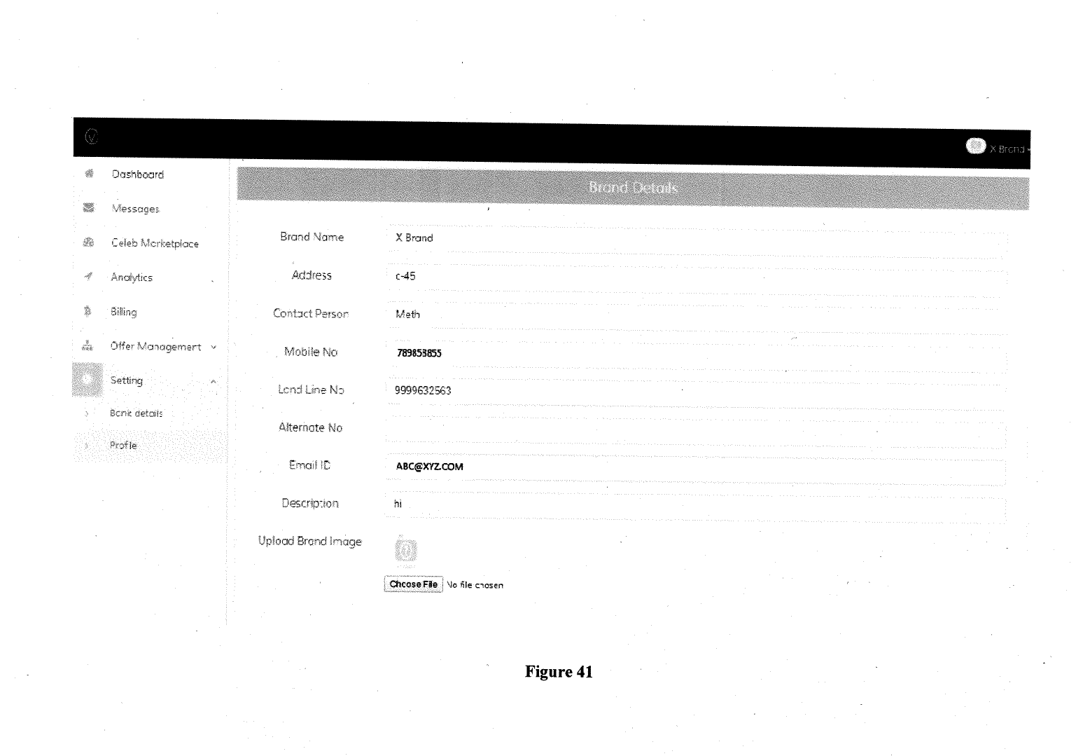

FIGS. 40 and 41 illustrates screenshots of pages of the brand interface showing the setting page for filling in bank details of brand in accordance with an embodiment of the present invention. On clicking setting tab of brand interface page, the tab expands in two sub sections, Bank Details and Profile. FIG. 40 illustrates the Bank Details section, a sub section of Setting Tab, allow the brand owners to enter their bank details or edit their existing bank details. Brand owners may do so by entering their relevant information into the text boxes provided on the page.

FIG. 41 illustrates the Profile subsection under the Setting tab. Brand owner's profile is a critical parameter as it plays an important role in influencing the influencers. The profile page of brand interface allows the brand owners to manage and edit their profiles. Information may be entered into various text boxes provided on the profile page. Brand owners may also upload an image representing the owner's brand.

The steps of the illustrated method described above herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, micro controller, or state machine. A processor may also be implemented as a combination of computing devices, e.g., a combination of a DSP and a microprocessor, a plurality of microprocessors, one or more microprocessors in conjunction with a DSP core, or any other such configuration.

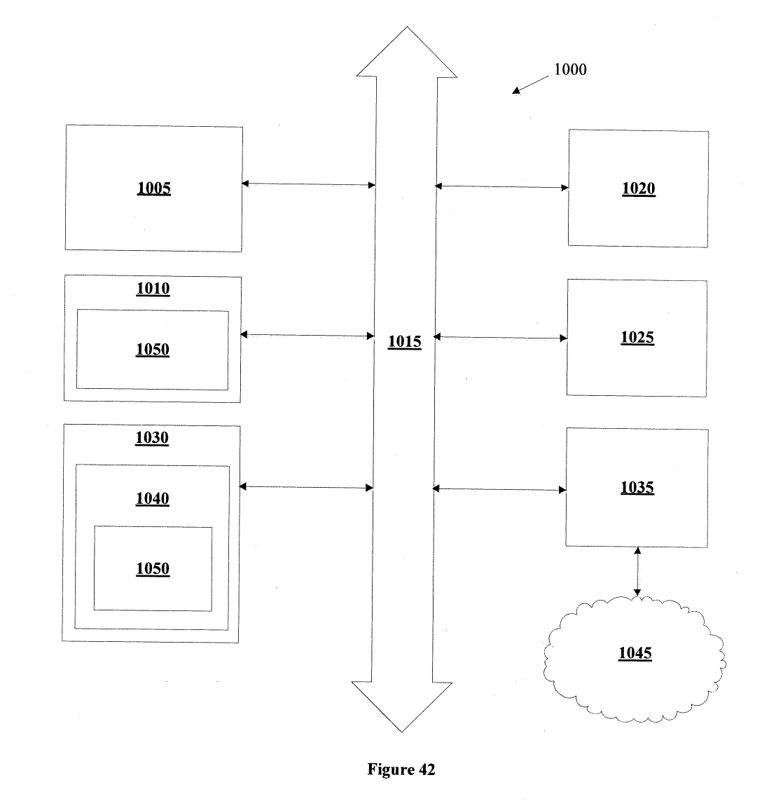

FIG. 42 illustrates a typical hardware configuration of a computer system, which is representative of a hardware environment for practicing the present invention. The computer system 1000 may include a set of instructions that can be executed to cause the computer system 1000 to perform any one or more of the methods disclosed. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a control system, a camera, a facsimile machine, a printer, a personal trusted device, a web appliance, a network router, switch or bridge, or any other machine capable of executing a set of instructions (sequential or otherwise) that specify actions to be taken by that machine.

Further, while a single computer system 1000 is illustrated, the term “system” shall also be taken to include any collection of systems or sub-systems that individually or jointly execute a set, or multiple sets, of instructions to perform one or more computer functions.

The computer system 1000 may include a processor 1005, e.g., a central processing unit (CPU), a graphics processing unit (GPU), or both. The processor 1005 may be a component in a variety of systems. For example, the processor 1005 may be part of a standard personal computer or a workstation. The processor 1005 may be one or more general processors, digital signal processors, application specific integrated circuits, field programmable gate arrays, servers, networks, digital circuits, analog circuits, combinations thereof, or other now known or later developed devices for analyzing and processing data. The processor 1005 may implement a software program, such as code generated manually (i.e., programmed).

The term “module” may be defined to include a plurality of executable modules. As described herein, the modules are defined to include software, hardware or some combination thereof executable by a processor, such as processor 1005. Software modules may include instructions stored in memory, such as memory 1010, or another memory device, that are executable by the processor 1005 or other processor. Hardware modules may include various devices, components, circuits, gates, circuit boards, and the like that are executable, directed, or otherwise controlled for performance by the processor 1005.

The computer system 1000 may include a memory 1010, such as a memory 1010 that can communicate via a bus 1015. The memory 1010 may be a main memory, a static memory, or a dynamic memory. The memory 1010 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1010 includes a cache or random access memory for the processor 1005. In alternative examples, the memory 1010 is separate from the processor 1005, such as a cache memory of a processor, the system memory, or other memory. The memory 1010 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1010 is operable to store instructions executable by the processor 1005. The functions, acts or tasks illustrated in the figures or described may be performed by the programmed processor 1005 executing the instructions stored in the memory 1010. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1020, such as a liquid crystal display (LCD), an organic light emitting diode (OLED), a flat panel display, a solid state display, a cathode ray tube (CRT), a projector, a printer or other now known or later developed display device for outputting determined information. The display 1020 may act as an interface for the user to see the functioning of the processor 1005, or specifically as an interface with the software stored in the memory 1010 or in the drive unit 1030.

Additionally, the computer system 1000 may include an input device 1025 configured to allow a user to interact with any of the components of system 1000. The input device 1025 may be a number pad, a keyboard, or a cursor control device, such as a mouse, or a joystick, touch screen display, remote control or any other device operative to interact with the computer system 1000.

The computer system 1000 may also include a disk or optical drive unit 1030. The disk drive unit 1030 may include a computer-readable medium 1040 in which one or more sets of instructions 1050, e.g. software, can be embedded. Further, the instructions 1050 may embody one or more of the methods or logic as described. In a particular example, the instructions 1050 may reside completely, or at least partially, within the memory 1010 or within the processor 1005 during execution by the computer system 1000. The memory 1010 and the processor 1005 also may include computer-readable media as discussed above.

The present invention contemplates a computer-readable medium that includes instructions 1050 or receives and executes instructions 1050 responsive to a propagated signal so that a device connected to a network 1045 can communicate voice, video, audio, images or any other data over the network 1045. Further, the instructions 1050 may be transmitted or received over the network 1045 via a communication port or interface 1035 or using a bus 1015. The communication port or interface 1035 may be a part of the processor 1005 or may be a separate component. The communication port 1035 may be created in software or may be a physical connection in hardware. The communication port 1035 may be configured to connect with a network 1045, external media, the display 1020, or any other components in system 1000, or combinations thereof. The connection with the network 1045 may be a physical connection, such as a wired Ethernet connection or may be established wirelessly as discussed later. Likewise, the additional connections with other components of the system 1000 may be physical connections or may be established wirelessly. The network 1045 may alternatively be directly connected to the bus 1015.

The network 1045 may include wired networks, wireless networks, Ethernet AVB networks, or combinations thereof. The wireless network may be a cellular telephone network, an 802.11, 802.16, 802.20, 802.1Q or WiMax network. Further, the network 1045 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the disclosure, any limitations arising on account of the same are not intended. As would be apparent to a person in the art, various working modifications may be made to the apparatus in order to implement the inventive concept as taught herein.

We claim:

1. A method for providing an influencer with an offer to endorse a brand's product or service over an advertising system, the advertising system is selectively in operative communication with one or more influencers and one or more brands; the method comprising the steps of:
selecting, at the advertising system, an influencer to endorse at least one product or service offered by a brand;
formulating an offer for the selected influencer to endorse at least one product or service by the brand; the offer comprises of an influencer identifier, a product identifier, a payment model and time period for endorsement;
notifying the selected influencer of the offer; and
providing the selected influencer to endorse the product or service upon a successful approval from the influencer.

2. The method as claimed in claim 1, further comprising registering one or more influencers and one or more brands on the advertising system.

3. The method as claimed in claim 1, further comprising providing a mobile software application customized for the influencers as an influencer application to be installed on an influencer device.

4. The method as claimed in claim 1, further comprising providing a brand interface customized for the brands to propose and manage offer to influencers.

5. The method as claimed in claim 1, wherein selecting includes evaluation of an influencer's awareness, appeal and relevance to a brand's image and their influence on consumer buying behavior.

6. The method as claimed in claim 1, wherein the payment model is Pay Per Tweet, Pay Per Lead and Pay Per Transaction.

7. The method as claimed in claim 1, wherein notifying the identified influencer on the mobile software application of the influencer device.

8. The method as claimed in claim 1, further comprising refusing the offer to influencer for endorsing the product or service upon a failure to approve from the influencer.

9. The method as claimed in claim 1, further comprising negotiating the offer with influencer for endorsing the product or service upon a query raised by the influencer with regards to the payment model or time period.

10. The method as claimed in claim 1, further comprising charging the brand for providing an offer to the influencer on the advertising system.

11. An advertising system for providing an influencer with an offer to endorse a brand's product or service, the advertising system is selectively in operative communication with one or more influencers and one or more brands; the advertising system comprising:
an influencer data repository configured to store the data relating to a plurality of registered influencers;
a brand data repository configured to store the data relating to a plurality of brand's offering product or service for endorsement; and
an advertising engine, in operative communication with influencer data repository, configured to select an influencer to endorse at least one product or service offered by a brand and formulate an offer for the selected influencer to endorse at least one product or service; the advertising engine further configured to notify the selected influencer of the offer and provide the selected influencer to endorse the product or service upon a successful approval from the influencer.

12. The advertising system as claimed in claim 11, further comprising an offer data repository, in operative communication with the advertising engine, configured to store the data relating to offers such as an influencer identifier, a product identifier, a payment model and time period for endorsement.

13. The advertising system as claimed in claim 11, further comprising a brand interface, selectively in operative communication with the advertising engine, configured to receive data from a user representing a brand owner or an administrator associated with the brand.

14. The advertising system as claimed in claim 11, further comprising an influencer interface, selectively in operative communication with the advertising engine, configured to transmit data to mobile software application on an influencer device.

15. The advertising system as claimed in claim 11, further comprising a channel integration platform in operative communication with the advertising engine, configured to perform security related and data integrity related checks on the content of the data.

16. The advertising system as claimed in claim 11, further comprising a registration module for registering one or more influencers and one or more brands.

17. The advertising system as claimed in claim 11, further comprising an influencer content module providing a mobile software application and contents customized for the influencers to download as an influencer application on the influencer device.

18. The advertising system as claimed in claim 11, further comprising a brand content module providing the brand interface with customized contents for proposing and managing offer to influencers.

19. The advertising system as claimed in claim 11, further comprising a reconciliation module operable to effect a payment transaction between the influencer and a brand.

20. The advertising system as claimed in claim 19, wherein the reconciliation module imposes a settlement commission to the brand for providing an offer to the influencer using the advertising system.

21. The advertising system as claimed in claim 11, further comprising a tracking module selectively in operative communication with the advertising engine and configured to track influencer's posts or tweets on the internet or social networking website and further configured to track the likes, clicks, leads or transactions of the target audience that follow influencer's tweet or posts such that the payment estimation is accurate between the brand owner and influencer.

22. The advertising system as claimed in claim 11, wherein the influencer is a celebrity such as a sports person, an entertainer or a well-known individual.

23. The advertising system as claimed in claim 11, wherein the advertising engine selects the influencer by evaluating the influencer's awareness, appeal and relevance to a brand's image and their influence on consumer buying behavior.

24. The advertising system as claimed in claim 11, wherein the payment model is Pay Per Tweet, Pay Per Lead and Pay Per Transaction.

25. The advertising system as claimed in claim 11, wherein the advertising engine notifies the identified influencer on the mobile software application of the influencer device.

26. A mobile software application for an influencer device, the mobile software application is selectively in operative communication with an advertising system, the mobile software application comprising:
a data repository for storing data;
a processor, selectively in operative communication with the data repository, configured to receive an offer for endorsement of products or services from a brand and provides the influencer an option to accept or reject or negotiate the offer; and
a user interface, selectively in operative communication with the processor, configured to provide an influencer at least one capability from the group comprising: viewing profile of the influencer; viewing statistics pertaining to the influencer; accepting and/or rejecting offers provided by a brand; managing offers and earnings.

27. The mobile software application as claimed in claim 26, wherein the processor further configured to negotiate the offer for endorsing the product or service upon a query input received from the influencer with regards to the payment model or time period.

28. The mobile software application as claimed in claim 26, wherein the processor further configured to reject the offer for endorsing the product or service upon a decline input received from the influencer based on an inept payment model or stringent time period.

29. The mobile software application as claimed in claim 26, wherein the mobile software application, upon successful installation on an influencer device, interacts with a web existence of the influencer.

30. The mobile software application as claimed in claim 29, wherein the web existence resides on a social networking website.

31. The mobile software application as claimed in claim 26, wherein the mobile software application allows the influencer to logon to a registered social network account such that influencer interacts with the web through the social network account.

32. The mobile software application as claimed in claim 26, wherein the influencer device is a mobile communication device.

33. The mobile software application as claimed in claim 26, wherein the mobile software application is a mobile app.

34. The mobile software application as claimed in claim 26, wherein the user interface provides an influencer with a menu type interface.

35. The mobile software application as claimed in claim 26, further comprising a mobile interface configured to transmit the data executed by the processor to the advertising system.

36. A system comprising:
an advertising system, having an advertising engine, for providing an influencer with an offer to endorse a brand's product or service; and
a mobile software application installed on an influencer device for receiving an offer for endorsement of products or service from a brand.

37. A computer program for providing an influencer with an offer to endorse a brand's product or service, comprising code means which when run on an advertising system, causes the advertising system to:
select an influencer to endorse at least one product or service offered by a brand;
formulate an offer for the selected influencer to endorse at least one product or service by the brand; the offer comprises of an influencer identifier, a product identifier, a payment model and time period for endorsement;
notify the selected influencer of the offer; and
provide the selected influencer to endorse the product or service upon a successful approval from the influencer.

38. A computer program product comprising a computer readable code means and a computer program according to claim 37.
